(19) United States
(12) Patent Application Publication
(10) Pub. No.: US 2004/0256754 A1
(43) Pub. Date: Dec. 23, 2004

(54) Three-dimensional image forming method and apparatus

(75) Inventor: Hideyuki Koguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/786,474

(22) Filed: Feb. 26, 2004

(30) Foreign Application Priority Data
Feb. 26, 2003 (JP) 2003-048697
Mar. 25, 2003 (JP) 2003-083423

(51) Int. Cl. B29C 41/02

(52) U.S. Cl. 264/40.1; 264/308; 425/375; 425/145

(57) ABSTRACT

The method and apparatus form as a two-dimensional image a first layer image including a three-dimensional object on a support based on two-dimensional image information and secure the first layer image as well as acquire first height information with which undulation corresponding to the three-dimensional object are reproducible, form a lamination image of the three-dimensional image having the undulation corresponding to the three-dimensional object by laminating ink solid ejected using a ink jet system on the first layer image based on the acquired first height information and fix the lamination image of the three-dimensional image formed on the support and having the undulation corresponding to the three-dimensional object.

### BACKGROUND OF THE INVENTION

1. Field of the Invention

The present invention relates to a three-dimensional image forming method and apparatus, and more specifically to a three-dimensional image forming method and apparatus based on an ink jet system, with which it is possible to form a three-dimensional image having a desired height gradation corresponding to the shape of an input three-dimensional object by converting or newly giving height information of the input three-dimensional object.

It should be noted here that in this specification, the term “three-dimensional image” means an image two-dimensionally formed on a sheet-like (planar) support and also having undulation (projections and depressions) in a height direction orthogonal to the plane of the support (differences of altitude, height distribution, or height gradation (for instance, undulation digitally controlled by an ink jet system so as to have a height of around several hundred μm from the support and have a predetermined height gradation such as a 256-step gradation (eight bits))), and is also simply referred to as the “relief image” in the present invention as distinguished from an ordinary image (two-dimensional image). Also, it is assumed that the term “image” includes text information, such as letters, as well as general image information. Further, in the present invention, the term “height gradation” means changes in height of undulation from the support and the term “height gradation step number (bit)” means the number of steps of the changes.

2. Description of the Related Art

As is well known, an ink jet system is widely adopted as a system that outputs a color image (that is, a two-dimensional color image) using a simple construction and therefore is capable of achieving size reduction and price reduction of a machine.

Usually, in a printer (ink jet printer) based on the ink jet system, a thermal head system or an electromechanical conversion element (piezoelectric element) system is employed. Also, in the ink jet printer, dye-based ink is generally used as a recording member. Further, with the print systems described above, printing is performed by causing the ink to soak into a recording medium that is a sheet-like (cut-sheet-like or web-like) recording target member such as a recording sheet.

As is also well known, up to now, with an image forming system such as an electrophotographic system or an electrostatic ink jet system, a monochrome (black-and-white) image or a color image is formed as a planar image on a sheet-like recording medium such as a recording sheet. Generally, this image is used to communicate desired information through visual recognition.

In order to form an image on a recording medium, such as a recording sheet, toner or ink containing colorants in predetermined colors is caused to adhere to the recording medium in accordance with image information and the colorants of the adhering toner or ink are melted and fixed on the recording medium. Therefore, the image formed on the recording medium with the image forming system is nothing but a two-dimensional planar image.

In contrast to this, a three-dimensional image has an advantage that it is capable of communicating three-dimensional information as well as planar visual information to a third party by utilizing shades resulting from differences of altitude, the sense of touch with fingers, and the like. Therefore, with the three-dimensional image, it becomes possible to diversify communicable information as compared with the planar image (two-dimensional image).

As a method for forming a three-dimensional image having such an advantage, for instance, it is possible to cite a method disclosed in JP 2002-278370 A with which expandable toner and non-expandable toner are combined together. With this method, first, a projection-shaped image having multiple wall surfaces is formed using the expandable toner. Then, multiple images of different kinds are formed on a support by applying the non-expandable toner to different wall surfaces of the projection-shaped image. Following this, heat fixation is performed in order to expand the expandable toner and to melt and fix the image formed with the non-expandable toner. With this conventional technique, however, there occurs a problem that it is difficult to perform the control of the expandable toner, it is hard to precisely align minute images with a projection shape formed through the expansion of the expandable toner, and it is impossible to perform fine control in a height direction.

Also, as a conventional three-dimensional image forming method based on the ink jet system described above, for instance, there is known a printer disclosed in JP 11-263004 A in which the ink jet system and a toner flying system are combined together. With this printer, first, printing is performed by causing ink to fly using the ink jet system. Next, toner particles are jetted onto a portion, in which printing has been performed with the ink, using the toner flying system. Finally, the drying of the ink and the melting/drying of the toner particles are performed with a heat-fixation system, thereby fixing a three-dimensional image formed with the toner particles.

This conventional technique is the same as the present invention to be described later in that a three-dimensional image is formed using the ink jet system. However, as to the control of the undulation (height) of the three-dimensional image, this document merely describes that it is possible to print an image where the degrees of undulation are changed by controlling the flying amount of each of the ink and the toner particles. Also, the drying of the ink on the recording medium and the drying/melting of the toner particles are performed at a final step through heat fixation, so that there is a problem that the fixation of the ink forming a lower layer on the recording medium and the fixation of the toner particles forming an upper layer on the lower layer ink tend to become insufficient.

Further, JP 2001-166809 A discloses a technique with which three-dimensional information of a human body (three-dimensional shape data) is acquired using a camera and a real three-dimensional model, that is, a three-dimensional object (including a three-dimensional object colored as appropriate) is created based on the acquired three-dimensional shape data.

As a method for creating a three-dimensional object, a method is described as an example with which a template having a shape close to the shape of a subject (model of a work to be processed) is prepared and this template is processed using a method such as cutting.

It should be noted here that in JP 2001-166809 A, it is described that a real three-dimensional model having a reduced thickness or the like may also be created by compressing the acquired three-dimensional shape data in a depth direction instead of using the data as it is.

Also, in JP 2001-166809 A, it is also described that the acquired three-dimensional shape data may be subjected to edge enhancement processing. However, the details of the edge enhancement processing, the effect thereof, and the like are not clearly described.

Further, in JP 2001-166809 A, there are described an example where at the time when a template having a shape close to the shape of a subject is processed based on acquired three-dimensional shape data using a method, such as cutting, a real three-dimensional model having a reduced thickness is created by compressing the acquired (given) three-dimensional shape data in the depth direction and a construction where edge enhancement processing is performed. However, a more concrete description thereof is not given.

It should be noted here that as another conventional technique of forming a three-dimensional image, there is known a method with which a two-dimensional wood-grain image or the like formed on wall paper for interior or exterior finish or the like is given undulation through embossing finish, thereby attempting to reproduce the material feeling of wood grains. However, there is a problem that it is difficult to make the pattern of the two-dimensional image coincide with the pattern of the embossed undulation and it is impossible to obtain a precise and elaborated three-dimensional image.

Also, there is known still another conventional technique with which a real three-dimensional model having a reduced thickness is created or a three-dimensional image is formed in an analog manner like in the case of a so-called relief. Even with this technique, however, there is a problem that in the case of a two-dimensional image whose groundwork is minute and elaborated, it is difficult to create a precise three-dimensional image in accordance with the two-dimensional image.

### SUMMARY OF THE INVENTION

The present invention has been made in view of the circumstances described above and a first object of the present invention is to provide a three-dimensional image forming method and apparatus based on an ink jet system, with which it is possible to solve the problems of the conventional techniques and to form a three-dimensional image having a desired and controlled height gradation corresponding to a three-dimensional shape in an image called “relief image” in the present invention.

In more detail, the first object of the present invention is to provide a three-dimensional image forming method and apparatus based on an ink jet system, with which it is possible to form a three-dimensional image having a desired height gradation corresponding to a three-dimensional shape by converting height information in input three-dimensional object information (three-dimensional information) or newly giving height information.

Also, the present invention has been made in view of the circumstances described above and a second object of the present invention is to provide a three-dimensional image forming method and apparatus, with which it is possible to solve the problems of the conventional techniques and to form a three-dimensional image having a desired height gradation corresponding to a three-dimensional shape and more favorably matching with human's visual characteristics in an image called “relief image” in the present invention.

In order to attain the first and second objects described above, the inventor of the present invention has embodied an idea that “input image information (three-dimensional information) is precisely converted/controlled in order to form a more sophisticated three-dimensional image” that is not found in JP 11-263004 A and JP 2001-166809 A described above.

Here, as described above, a three-dimensional image forming apparatus based on an ink jet system has a relatively simple construction but is extremely effective at forming a high-quality image. In particular, such an image forming apparatus is indispensable for forming a high-quality color image. Therefore, if it is possible to further add a high-precision image information conversion function to this apparatus, it becomes possible to improve the apparatus into a more effective three-dimensional image forming means.

Also, at the time of formation of a three-dimensional image, it is conceived that the addition of a thought that input image information (three-dimensional information) is converted/controlled with precision, in particular, the addition of a thought that the input image information is converted/controlled into information concerning height characteristics in accordance with human's visual characteristics contributes to the formation of a more effective three-dimensional image.

In order to attain the first and second objects described above, a first aspect according to the present invention provides a three-dimensional image forming method for forming a three-dimensional image having undulation corresponding to a three-dimensional object on a support using an ink jet system, comprising forming as a two-dimensional image a first layer image including the three-dimensional object on the support based on two-dimensional image information, securing the first layer image on the support, acquiring first height information with which the undulation corresponding to the three-dimensional object are reproducible on the support, forming a lamination image of the three-dimensional image having the undulation corresponding to the three-dimensional object by laminating ink solid ejected using the ink jet system on the first layer image secured on the support based on the acquired first height information, and fixing the lamination image of the three-dimensional image formed on the first layer image and having the undulation corresponding to the three-dimensional object.

Preferably, the first layer image is formed using an ink jet system that is the same as or different from the ink jet system used to form the lamination image of the three-dimensional image.

And, preferably, the lamination image of the three-dimensional image is formed using an ink jet system that is capable of laminating the ink solid by ejecting ink containing a thermoplastic solid or ultraviolet cure ink, and the first layer image is formed using an ink jet system that is capable of forming a two-dimensional image by ejecting water-based ink, oil-based ink or ultraviolet cure ink for image recording.

And, preferably, first fixation processing performed to secure the first layer image on the support and second fixation processing performed to fix the lamination image of the three-dimensional image formed on the first layer image are different from each other.

Also, in order to attain the first object described above, in a first embodiment in the first aspect according to the present invention, preferably, the step of acquiring the first height information comprises the steps of acquiring second height information concerning a height of the three-dimensional object from inputted three-dimensional object information, and converting the acquired second height information into desired height information with which the undulation corresponding to the three-dimensional object are reproducible on the support as the first height information.

And, preferably, the three-dimensional object information includes three-dimensional shape information concerning the three-dimensional object, and the second height information is information concerning a height in the three-dimensional shape information, and the two-dimensional image information is two-dimensional image data inputted in addition to the three-dimensional object information.

Further, preferably, the two-dimensional image information and the three-dimensional object information are acquired from the inputted three-dimensional image information.

Moreover, in order to attain the first object described above, in a second embodiment of the first aspect according to the present invention, preferably, the two-dimensional image information is inputted information, and the step of acquiring the first height information comprises the step of calculating as the first height information desired height information, with which the undulation corresponding to the three-dimensional object and corresponding to at least one part of positions on the first layer image are reproducible on the support, from the inputted two-dimensional image information.

And, in order to attain the first object described above, in a third embodiment of the first aspect according to the present invention, preferably, the two-dimensional image information is inputted information, and the step of acquiring the first height information comprises the steps of calculating third height information corresponding to at least one part of positions on the first layer image from the inputted two-dimensional image information, and converting the calculated third height information into desired height information with which the undulation corresponding to the three-dimensional object are reproducible on the support as the first height information.

In order to attain the second object described above, in a fourth embodiment of the first aspect according to the present invention, preferably, the step of acquiring the first height information comprises the steps of acquiring second height information concerning a height of the three-dimensional object from inputted three-dimensional object information, and converting the acquired second height information based on human's visual characteristics into desired height information with which the undulation corresponding to the three-dimensional object are reproducible on the support.

Preferably, the three-dimensional object information includes three-dimensional shape information concerning the three-dimensional object, and the second height information is information concerning a height in the three-dimensional shape information.

And, preferably, the two-dimensional image information is two-dimensional image data inputted in addition to the three-dimensional object information.

Further, preferably, the two-dimensional image information and the three-dimensional object information are acquired from inputted three-dimensional image information.

Preferably, the step of converting the second height information based on the human's visual characteristics comprises the step of determining a height frequency based on a grainy feeling or a glossy feeling, which is to be felt with human's sense of sight, obtained using samples having different surface roughness, or the step of converting the second height information based on the human's visual characteristics comprises the step of converting a height gradation in accordance with a height resolution visibility curve.

Preferably, the step of converting the height gradation in accordance with the height resolution visibility curve is performed so that selective enhancement or suppression is performed in a region in which the human's sense of sight is enhanced, or the step of converting the height gradation in accordance with the height resolution visibility curve is performed so that information cut is performed in a region in which the human's sense of sight loses substantial sensitivity.

In order to attain the second object described above, in a fifth embodiment of the first aspect according to the present invention, preferably, the two-dimensional image information is inputted information, and the step of acquiring the first height information comprises the step of calculating desired height information, with which the undulation corresponding to the three-dimensional object and corresponding to at least one part of positions on the first layer image are reproducible on the support, from the inputted two-dimensional image information based on human's visual characteristics.

In order to attain the second object described above, in a sixth embodiment of the first aspect according to the present invention, preferably, the two-dimensional image information is inputted information, and the step of acquiring the first height information comprises the steps of calculating third height information corresponding to at least one part of positions on the first layer image from the inputted two-dimensional image information, and converting the thus calculated third height information based on human's visual characteristics into desired height information with which the undulation corresponding to the three-dimensional object are reproducible on the support.

In the meantime, in order to attain the first and second objects described above, a second aspect according to the present invention provides a three-dimensional image forming apparatus for forming a three-dimensional image having undulation corresponding to a three-dimensional object on a support using an ink jet system, comprising first forming means for forming as a two-dimensional image a first layer image including the three-dimensional object on the support based on two-dimensional image information, securing means for securing the first layer image on the support, first information acquiring means for acquiring first height information with which the undulation corresponding to the three-dimensional object are reproducible on the support, second forming means for forming a lamination image of the three-dimensional image having the undulation corresponding to the three-dimensional object by laminating ink solid ejected using the ink jet system on the first layer image secured on the support based on the acquired first height information, and a fixing means for fixing the lamination image of the three-dimensional image formed on the first layer image and having the undulation corresponding to the three-dimensional object.

Preferably, the first forming means and the second forming means are each an ink jet head using a same or different ink jet system.

And, preferably, the second forming means is an ink jet head that forms the lamination image of the three-dimensional image having the undulation corresponding to the three-dimensional object by laminating the ink solid through ejection of ink containing a thermoplastic solid or ultraviolet cure ink, and the first forming means is an ink jet head that forms a two-dimensional image by ejecting water-based ink, oil-based ink or ultraviolet cure ink for image recording.

Further, preferably, the securing means and the fixing means perform different fixation processing.

In order to attain the first object described above, in the first embodiment of the second aspect according to the present invention, preferably, the first information acquiring means includes second information acquiring means for acquiring second height information concerning a height of the three-dimensional object from inputted three-dimensional object information, and first information converting means for converting the second height information acquired by the second information acquiring means into desired height information with which the undulation corresponding to the three-dimensional object are reproducible on the support.

And, in order to attain the first object described above, in a second embodiment of the second aspect according to the present invention, preferably, the two-dimensional image information is inputted information, and the first information acquiring means includes first information calculating means for desired height information, with which the undulation corresponding to the three-dimensional object and corresponding to at least one part of positions on the first layer image are reproducible on the support, from the inputted two-dimensional image information.

Moreover, in order to attain the first object described above, in a third embodiment of the second aspect according to the present invention, preferably, the two-dimensional image information is inputted information, and the first information acquiring means includes second information calculating means for calculating third height information corresponding to at least one part of positions on the first layer image from the inputted two-dimensional image information, and second information converting means for converting the third height information calculated by the second information calculating means into desired height information with which the undulation corresponding to the three-dimensional object are reproducible on the support.

Now, in order to attain the second object described above, in a fourth embodiment of the second aspect according to the present invention, preferably, the first information acquiring means includes the second information acquiring means for acquiring second height information concerning a height of the three-dimensional object from inputted three-dimensional object information, and third information converting means for converting the second height information acquired by the second information acquiring means into desired height information with which the undulation corresponding to the three-dimensional object are reproducible on the support based on human's visual characteristics.

And, in order to attain the second object described above, in a fifth embodiment of the second aspect according to the present invention, preferably, the two-dimensional image information is inputted information, and the first information acquiring means includes third information calculating means for calculating height information, with which the undulation corresponding to the three-dimensional object and corresponding to at least one part of positions on the first layer image are reproducible on the support, from the inputted two-dimensional image information based on human's visual characteristics.

Further, in order to attain the second object described above, in a sixth embodiment of the second aspect according to the present invention, preferably, the two-dimensional image information is inputted information, and the first information acquiring means includes the second information calculating means for calculating third height information corresponding to at least one part of positions on the first layer image from the inputted two-dimensional image information, and fourth information converting means for converting the third height information calculated by the second information calculating means into desired height information with which the undulation corresponding to the three-dimensional object are reproducible on the support based on human's visual characteristics.

According to the present invention, on the basis of height information extracted from inputted three-dimensional information or height information calculated from two-dimensional information, a three-dimensional image can be formed in which a material feeling is expressed in a more preferable state or a state more suited for the human's visual characteristics (that is, a three-dimensional image having an improved material feeling) as compared with a three-dimensional image obtained by using the input information as it is (that is, an original three-dimensional image).

That is, with the three-dimensional image forming method or apparatus according to the present invention, consideration is given to a fact that an observer's impression of an actual three-dimensional object differs from his/her impression of a product where the three-dimensional object is printed as a three-dimensional image or reproduced as a print or the like, and the height information described above is converted so as to have direction properties with which the observer of the three-dimensional image printed or reproduced as a print or the like feels that the printed or reproduced image is more “real” or more “favorable”. With this construction, it becomes possible to form a favorable three-dimensional image.

Such an idea is not found in any conventional techniques and is a feature of the present invention. Here, as to the conversion of the height information or the conversion of the height information into information having more preferable directional properties from the viewpoint of the human's visual characteristics, it is possible to use various conversion methods in the image processing field by making slight changes thereto or use them for reference purposes, as will be described later

### BRIEF DESCRIPTION OF THE DRAWINGS

Preferred embodiments of the present invention will be described in detail based on the following figures, wherein:

FIG. 1 is a block diagram showing a schematic construction of a three-dimensional image forming apparatus according to an embodiment of the present invention;

FIG. 2 is a more concrete schematic conceptual diagram of the three-dimensional image forming apparatus shown in FIG. 1;

FIG. 3A is a flowchart illustrating the outline of a first operation example in the case where the apparatus according to the embodiment shown in FIGS. 1 and 2 is used;

FIG. 3B is a block diagram showing a schematic construction of an embodiment of a data processing unit used to carry out the first operation example shown in FIG. 3A;

FIG. 4 shows an example of height conversion of a three-dimensional image according to the embodiment;

FIG. 5 illustrates a concept of conversion of three-dimensional object inherent information;

FIG. 6 shows a first conversion example of height gradation;

FIG. 7 shows a second conversion example of the height gradation;

FIG. 8 shows a third conversion example of the height gradation;

FIG. 9 shows a fourth conversion example of the height gradation;

FIG. 10 shows a fifth conversion example of the height gradation;

FIGS. 11A and 11B are a perspective view and a sectional view showing schematic configurations of directional properties that are an example and another example of two-dimensional information of undulation (projection/depression), respectively;

FIG. 12A illustrates schematically a method for separating surface information and interface information from each other in a three-dimensional object produced by forming a film on a support;

FIG. 12B illustrates schematically the surface information and the interface information separated from each other by the separation method shown in FIG. 12A;

FIG. 13 illustrates a method for separating scattering characteristics at surfaces and scattering characteristics at an interface from each other in a three-dimensional object (lamination member) produced by overlaying multiple layers on each other;

FIG. 14 illustrates the incident angle dependency of a light absorption factor of a film (layer) in a three-dimensional object produced by forming a film on a support;

FIG. 15 illustrates an influence of the size distribution of resin particles in a lamination member composed of layers containing the resin particles;

FIGS. 16A and 16B are each an explanatory diagram showing a case where a difference occurs to a formed three-dimensional image in accordance with whether intermediate layers are inserted when multiple layers are overlaid on each other, FIG. 16A is a color three-dimensional image having the intermediate layers and FIG. 16B is a color three-dimensional image having no intermediate layer;

FIG. 17A is a flowchart illustrating the outline of a second operation example in the case where the apparatus according to the embodiment shown in FIGS. 1 and 2 is used;

FIG. 17B is a block diagram showing a schematic construction of an embodiment of a data processing unit used to carry out the second operation example shown in FIG. 17A;

FIG. 18A is a flowchart illustrating the outline of a third operation example in the case where the apparatus according to the embodiment shown in FIGS. 1 and 2 is used;

FIG. 18B is a block diagram showing a schematic construction of an embodiment of a data processing unit used to carry out the third operation example shown in FIG. 18A;

FIG. 19A is a flowchart illustrating the outline of a fourth operation example in the case where the apparatus according to the embodiment shown in FIGS. 1 and 2 is used;

FIG. 19B is a block diagram showing a schematic construction of an embodiment of a data processing unit used to carry out the fourth operation example shown in FIG. 19A,

FIG. 20 is an explanatory diagram showing an example of human's visual characteristics;

FIG. 21A is a flowchart illustrating the outline of a fifth operation example in the case where the apparatus according to the embodiment shown in FIGS. 1 and 2 is used;

FIG. 21B is a block diagram showing a schematic construction of an embodiment of a data processing unit used to carry out the fifth operation example shown in FIG. 21A;

FIG. 22A is a flowchart illustrating the outline of a sixth operation example in the case where the apparatus according to the embodiment shown in FIGS. 1 and 2 is used; and

FIG. 22B is a block diagram showing a schematic construction of an embodiment of a data processing unit used to carry out the sixth operation example shown in FIG. 22A;

### DETAILED DESCRIPTION OF THE PREFERRED EMBODIMENTS

The three-dimensional image forming method and apparatus according to the present invention will be described in detail below based on preferred embodiments illustrated in the accompanying drawings.

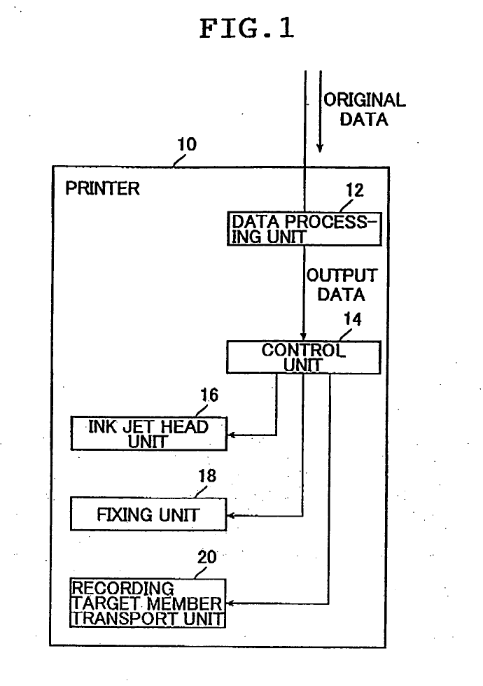

First, a three-dimensional image forming method according to a first aspect of the present invention and a three-dimensional image forming apparatus according to a second aspect of the present invention will be described with reference to FIGS. 1 to 18B.

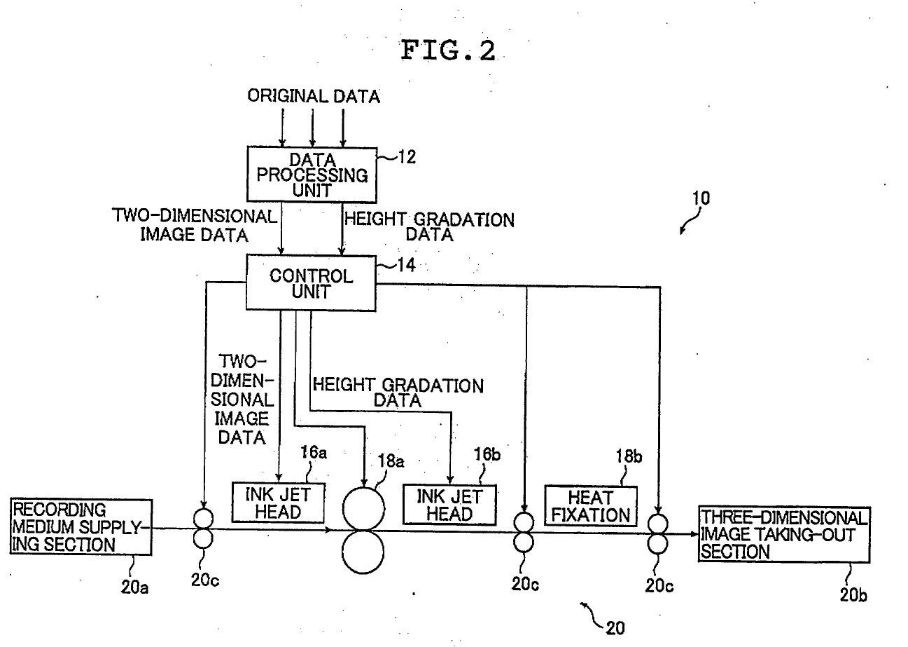

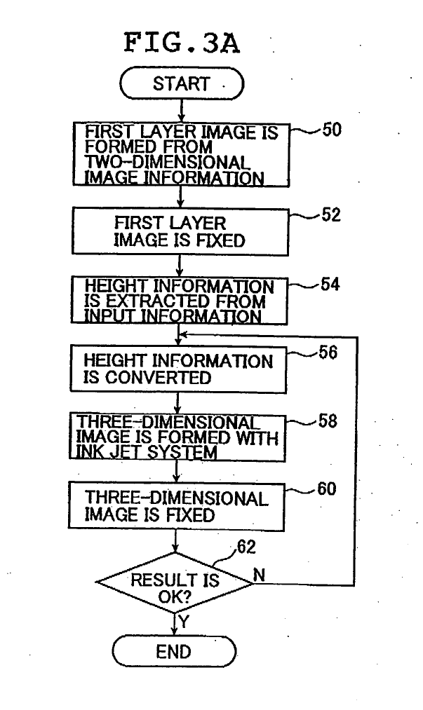

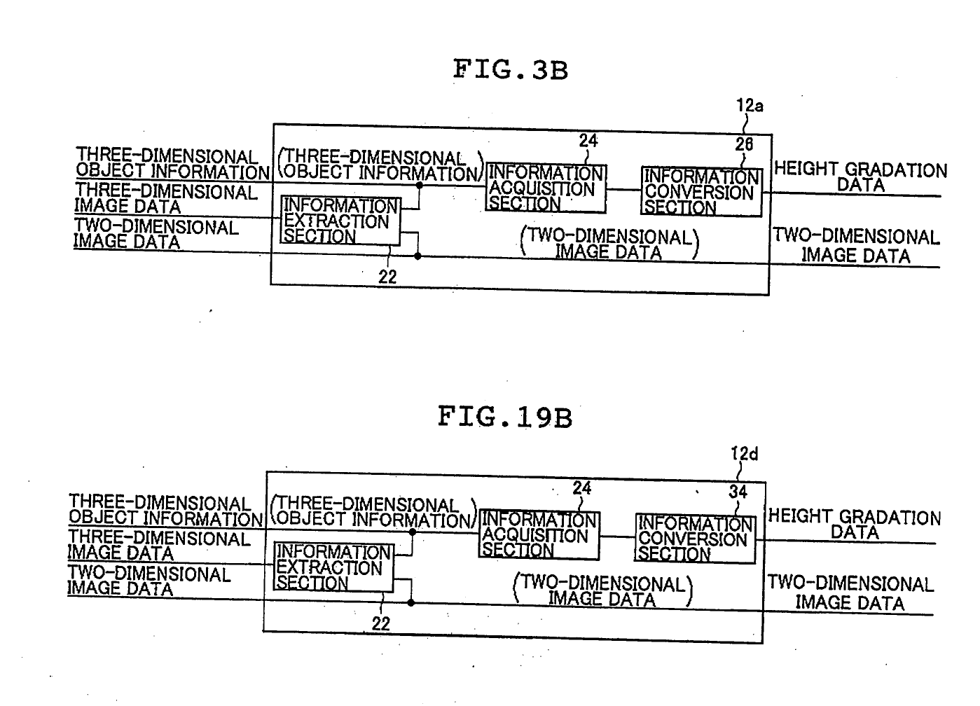

FIG. 1 is a block diagram showing a schematic construction of an embodiment of the three-dimensional image forming apparatus (hereinafter also simply referred to as the “forming apparatus”) according to the second aspect of the present invention. Also, FIG. 2 is a more concrete schematic conceptual diagram of the forming apparatus shown in FIG. 1. Further, FIG. 3A is a flowchart illustrating the outline of a first embodiment of an operation in the case where the forming apparatus according to the embodiment shown in FIGS. 1 and 2 is used, that is, the three-dimensional image forming method (hereinafter also simply referred to as the “forming method”) according to the first aspect of the present invention. Also, FIG. 3B is a block diagram showing a schematic construction of an embodiment of a data processing unit used in the forming method of the first embodiment. Note that it is possible to use the three-dimensional image forming apparatus shown in FIGS. 1 and 2 also in second and third embodiments of each of the three-dimensional image forming method according to the first aspect of the present invention and the forming apparatus according to the second aspect as well as first to third embodiments of each of a third aspect of the forming method and a fourth aspect of the forming apparatus to be described later by changing the internal construction of the data processing unit.

First, a construction of the three-dimensional image forming apparatus according to this embodiment will be described with reference to FIG. 1.

A forming apparatus (hereinafter also referred to as the “printer”) 10 according to this embodiment forms and fixes a two-dimensional planar image (first layer image) on a support or preferably a sheet-like recording medium, such as a recording sheet, based on two-dimensional image data. Then, the forming apparatus 10 forms a lamination image by laminating ink solid on the first layer image on the recording medium in accordance with a three-dimensional object (in particular, the height thereof) or preferably in accordance with digitally controlled height gradation by ejecting ink using an ink jet system based on three-dimensional object information contained in the two-dimensional image. Then, the forming apparatus 10 performs fixation or preferably performs heat fixation in a non-contact manner so as not to lose the height gradation of the lamination image. In this manner, the forming apparatus 10 forms a three-dimensional image (three-dimensional picture) having undulation corresponding to the three-dimensional object.

Here, the three-dimensional image formed in the present invention is an image two-dimensionally formed on a sheet-like support and also having undulation in a height direction orthogonal to the plane of the support (differences of altitude, height distribution, or height gradation (for instance, undulation digitally controlled by the ink jet system so as to have a height of around several hundred μm from the support and have a predetermined height gradation such as a 256-step gradation (eight bits))). In the present invention, as distinguished from an ordinary image (two-dimensional image), it is possible to say that the three-dimensional image is a “relief image” having a lamination image laminated on a first layer image that is a two-dimensional image so as to have a height controlled in accordance with a three-dimensional object in the two-dimensional image. Note that in the present invention, the term “height gradation” means changes in height of the lamination image from the support and the term “height gradation step number (bit)” means the number of steps of the changes in height from the support.

The support used in the present invention is a two-dimensional, that is, planar or sheet-like thin recording target member and is not specifically limited so long as it is possible to form a two-dimensional image thereon as a first layer image, to surely fix the formed two-dimensional image thereon, and to form a lamination image composed of multiple layers and having a gradation (undulation) in a height direction on the first layer two-dimensional image. For instance, the support may have a cut sheet shape or a web (long) shape. Also, it is sufficient that the support is a recording target member or a recording medium on which it is possible to record or form a two-dimensional image using a two-dimensional image recording system. Therefore, it is possible to use a recording target member or a recording medium, on which an image is formed by causing ink solid such as a colorant to adhere and fixing it, or to use a recording target member or a recording medium that develops colors by itself for formation of an image. For instance, it is possible to cite conventionally known recording media such as a recording sheet, a film (resin film), and a metallic plate. Note that the size and thickness of the support is not specifically limited so long as the support is used as an ordinary recording medium, and may be selected as appropriate in accordance with a two-dimensional image recording system adopted or more preferably in accordance with ink or ink solid used to form the lamination image. As the recording sheet, a recording sheet having a thickness of around 100 μm to several mm may be used, for instance.

The two-dimensional image recorded or formed on such a support is not specifically limited so long as it is an image recorded or formed on the support as a first layer image, and may be selected as appropriate in accordance with its recording system. For instance, the two-dimensional image may be a thin layer image formed by causing toner or ink solid such as a colorant, used in an ink jet recording system, an electrophotographic recording system, or the like to be described later to adhere and fixing it on the support. Alternatively, the two-dimensional image may be a thin layer image formed through coloring, development, and fixation of a coloring layer formed on a recording medium or a recording target member. In either case, the two-dimensional image serves as a base image of a lamination image to be formed thereon. Note that the two-dimensional image is not limited to monochrome or color image information and may include one of or both of text information, such as letters, and line image information.

The lamination image on the two-dimensional image formed on the support is formed by laminating multiple layers ((n−1) layers) from the second layer to the nth layer on the first layer two-dimensional image by ejecting ink solid using an ink jet system, and is laminated so as to have undulation (differences of altitude, height distribution, or height gradation, for instance) having height corresponding to the three-dimensional object in the two-dimensional image (for instance, so as to have a height of several hundred μm (300 μm to 500 μm, for instance) from the surface of the support). Here, the layer thickness (step height) of each layer of the lamination image composed of the (n−1) layers from the second layer to the nth layer is not specifically limited and may be selected as appropriate in accordance with the maximum height of the lamination image, the height gradation (gradation step number n) of the three-dimensional image, and the like. Also, it does not matter whether respective layers have the same thickness or different thickness For instance, when the height of the lamination image is 300 μm to 500 μm and the height gradation has 256 steps, the thickness may be set at 1 μm to 2 μm. Needless to say, the height gradation of the three-dimensional image and the number of layers (n−1) of the lamination image are not specifically limited and may be selected as appropriate in accordance with a desired three-dimensional image, the two-dimensional image, and the three-dimensional object therein.

Here, as shown in FIG. 1, the forming apparatus (printer) 10 according to this embodiment includes a data processing unit 12, a control unit 14, an ink jet head unit 16, a fixing unit 18, and a recording target member transport unit 20.

As shown in FIGS. 1 and 2, the data processing unit 12 functions as a first information acquisition section (means). In more detail, the data processing unit 12 receives original data, such as a signal inputted from an upstream image information source (upper apparatus), information (two-dimensional image information, information of a three-dimensional object, three-dimensional image information), and image data (two-dimensional image data, three-dimensional image data), obtains height gradation data (first height information) by executing necessary data processing, and outputs output data such as two-dimensional image data and height gradation data.

Next, the control unit 14 receives the output data from the data processing unit 12 and performs control of respective portions of the printer 10, in particular the ink jet head unit 16 (16a and 16b), the fixing unit 18 (18a and 18b), and the recording target member transport unit 20 (20a, 20b, and 20c).

It should be noted here that the forming apparatus 10 of this embodiment first records a two-dimensional image of a three-dimensional object on a sheet-like (cut-sheet-like or web-like (long)) recording target member or the like by ejecting ordinary image recording ink using the ink jet head unit 16, and dries the two-dimensional image for fixation. Then, the forming apparatus 10 forms, on the two-dimensional image, undulation (three-dimensional structure) corresponding to the three-dimensional object recorded as the two-dimensional image using heat-melting-type ink. In this manner, a three-dimensional image having undulation corresponding to the three-dimensional object of the two-dimensional image recorded on the sheet-like recording target member and expressing the height gradation with the undulation is formed on the two-dimensional image.

When forming a three-dimensional image of a three-dimensional structure, the heat-melting-type ink used is preferably transparent or lightly colored in the case of making use of the information of the base two-dimensional image, but opaque ink may be used in the case of overwriting the two-dimensional image. In the latter case, the opaque ink is used in a laminated manner and the image is tapered toward the upper side. Therefore, the picture (image) on the lower side becomes slightly larger and hence the colored edges can be seen. Only the colored edges can be used to form a three-dimensional image, that is, a three-dimensional image having a three-dimensional structure.

Accordingly, as shown in FIG. 2, the ink jet head unit 16 includes an ink jet head 16a that serves as a first image forming means of the present invention and records the two-dimensional image (first layer image) on the sheet-like (planar) recording medium and an ink jet head 16b that serves as a second image forming means of the present invention and forms the lamination image having the undulation corresponding to the three-dimensional object in the two-dimensional image recorded on the recording medium on the two-dimensional image by laminating ink solid so that a height gradation is expressed by the undulation.

As the ink jet head 16a, for instance, it is possible to use a two-dimensional image recording ink jet head that records two-dimensional (monochrome or color) image using multiple kinds of ink such as ordinary image recording monochrome (black) ink and color ink. As the two-dimensional image recording ink, for instance, it is possible to use various types of ink such as water-based ink, oil-based ink, solid ink, UV ink(ultraviolet cure ink), and ink composed of a solvent containing solid matter such as a colorant or a resin. Also, it is possible to cite conventionally known ink jet heads and solid ink jet heads of thermal type, piezoelectric type, and electrostatic type that use liquid, toner, liquid toner, or the like as ink.

Also, as the ink jet head 16b, for instance, it is possible to use a three-dimensional structure forming ink jet head that forms undulation expressing a height gradation corresponding to a three-dimensional object by laminating ink solid using ink of heat-melting type or ultraviolet cure type (UV ink). As the three-dimensional structure forming ink, for instance, it is possible to use various kinds of ink with which it is possible to laminate ink solid on a recording medium, such as heat-melting ink, solvent-melting ink, solid ink, ink containing a thermoplastic solid, UV ink, and ink composed of a solvent containing solid matter such as a colorant or a resin. Also, as the ink jet head 16b, for instance, it is possible to cite conventionally known ink jet heads and solid-matter-ejection-type ink jet heads of thermal type, piezoelectric type, and electrostatic type using the ink described above. Note that liquid, toner, liquid toner, or the like may be used as the ink of the ink jet head 16b so long as it is possible to laminate ink solid on the recording medium. Also, in the present invention, it is preferable that ink of heat-melting type or ink or toner containing a thermoplastic resin (having a grain shape) as its main ingredient, is used as the three-dimensional structure forming ink.

It should be noted that, when using UV ink made of a photosensitive resin reacting with ultraviolet light, a lamination image can be formed sequentially by fixing and curing each layer image with ultraviolet light for image lamination. In this case, the second and the following layer images may only be formed using UV ink, but in addition to these layer images, the first layer image may also be formed using UV ink.

As described above, in the present invention, it is preferable that, as shown in FIG. 2, the ink jet head unit 16 includes two kinds of ink jet heads that are the two-dimensional image recording ink jet head 16a and the three-dimensional structure forming ink jet head 16b. However, the present invention is not limited to this and the ink jet head unit 16 (16a and 16b) may include only one kind of shared ink jet head that is applicable to both of the ordinary image recording ink and the heat-melting-type ink.

With the use of the single shared ink jet head as the ink jet head unit 16 (16a and 16b), a two-dimensional image having undulation (three-dimensional structure) and expressing a height gradation is formed in the present invention as a three-dimensional image directly on a sheet-like recording target member using multiple kinds of heat-melting-type ink in monochrome (black) and other colors.

Further, in the embodiment shown in FIG. 2, as the first image forming means for forming the first layer image of the present invention, the two-dimensional image recording ink jet head 16a is used. However, the present invention is not limited to this and it is possible to use any other conventionally known two-dimensional image forming means so long as it is capable of recording a two-dimensional image (including a line image, such as a letter, and multi-step gradation image) on a sheet-like recording target member. For instance, it is possible to cite a known image recording unit adopting an electrophotographic system using liquid, toner, liquid toner, or the like, of heat-transfer recording type, or of type where ink or toner is caused to adhere onto a recording target member (support) through printing or the like. Also, it is possible to use a conventionally known image recording unit of a silver salt photographic system or dye-sublimation image recording type, where a recording target member (support) itself generates an image, so long as it is capable of forming a two-dimensional image on which it is possible to form a lamination image using ink solid.

Also, as the second image forming means for forming the solid matter lamination image of the present invention, it is preferable that a non-contact-type image recording unit adopting a non-contact-type image recording method is used because it is required to stack a solid matter thin layer image in order to form a lamination image (which can also be called “three-dimensional information layer”) having a height gradation (height information). In the illustrated case, the three-dimensional structure forming ink jet head 16b is used, although the present invention is not limited to this and a contact-type image recording unit, which uses an image recording method based on an electrophotographic system or a heat-transfer system using resin toner such as a thermoplastic resin, may be used so long as it is capable of forming the lamination image.

Therefore, the fixing unit 18 includes a first fixing section 18a serving as a securing means for fixing and securing the first layer two-dimensional image formed on the recording target member by the ink jet head 16a on the recording target member and a second fixing section 18b for fixing an ink solid lamination image formed on the first layer image on the recording target member by the ink jet head 16b.

Here, the first fixing section 18a is not specifically limited so long as it is capable of firmly and reliably fix the first layer two-dimensional image formed on the recording target member by the ink jet head 16a. For instance, it is possible to use a conventionally known fixing unit or the like that performs fixation processing (method), such as heat fixation like contact heat fixation using a heat roll or the like, non-contact heat fixation using an infrared heater or the like, UV fixation, fixation based on oxidation polymerization or the like, or pressure fixation. Note that when the recording target member is a porous support such as paper, in order to cause the ink to reliably soak into internal gaps (holes) between fibers of the support and to be firmly anchored in the support, it is preferable that a conventionally known fixing unit or the like is used which performs pressure fixation or heat fixation, preferably pressure fixation, or more preferably both of the pressure fixation and the heat fixation. Note that in the embodiment shown in FIG. 2, the pressure fixation and the heat fixation are used in combination by setting at least one of paired rollers of the first fixing section 18a as a heat roller.

It should be noted here that when the first layer image is formed using an image forming means of another system in place of the ink jet head 16a, it is sufficient that a fixation method suited for fixing the first layer image on the recording target member, such as a conventionally known fixation method like heat fixation, pressure fixation, UV fixation, or fixation based on oxidation polymerization, drying, or the like, is used in accordance with the image forming system adopted by the image forming means.

On the other hand, the second fixing section 18b is provided in order to fix the ink solid lamination image formed on the first layer image on the recording target member, so that it is possible to use a fixation unit or the like that performs any kinds of fixation processing (method) so long as it is possible to perform fixation without causing a loss of the height gradation and the height information expressed by the lamination image. Therefore, it is possible to use heat fixation, UV fixation, fixation based on oxidation polymerization or the like, but it is preferable that non-contact heat fixation is selected because it is required to reliably maintain and fix the height gradation and the height information.

As described above, it is preferable that the fixation processing performed by the fixing section 18a and the fixation processing performed by the fixing section 18b are different from each other. In the above case, the first fixing section 18a performs pressure fixation and/or heat fixation and the second fixing section 18b performs non-contact heat fixation.

In the case shown in FIG. 2, the recording target member transport unit 20 includes: a recording target member supplying section 20a for supplying an unused recording target member; a recording target member taking-out section 20b for taking out a recording target member on which a three-dimensional image has been formed; and a transport mechanism composed of a transport roller pair 20c that transports the recording target member supplied from the recording target member supplying section 20a to the ink jet head 16a for formation of a first layer image, the heat roller pair that constitutes the first fixing section 18a for fixing the first layer image and also functions as a transport roller pair that transports the recording target member to the ink jet head 16b for formation of a solid matter lamination image, a transport roller pair 20c that transports the recording target member, on which the solid matter lamination image has been formed, to the second fixing section for fixation of the solid matter lamination image, and a transport roller pair 20c that transports the three-dimensional image fixed on the recording target member by the second fixing section and having undulation expressing height information to the recording target member taking-out section 20b.

It should be noted here that in the transport mechanism, the number of the transport roller pairs 20c, the number of the heat roller pairs, and the intervals between the roller pairs may be set as appropriate in accordance with the size and type (cut-sheet or web, for instance) of the recording target member and the like. Also, the transport mechanism used in the present invention is not specifically limited so long as it is capable of transporting the recording target member. For instance, it is possible to use a conventionally known transport mechanism, such as a belt conveyor, aside from the transport mechanism using the roller pairs.

Here, in respective embodiments to be described later, among the aforementioned construction elements of the forming apparatus (printer) 10 according to this embodiment, the ink jet head unit 16, the fixing unit 18, the recording target member transport unit 20, and the control unit 14 that performs control of these constructions elements have the same functions as in this embodiment. For instance, it is possible to use the construction elements applied to the ordinary two-dimensional image recording ink jet head 16a and the heat-melting-type ink jet head 16b also in the embodiments to be described later. Therefore, the detailed description of these construction elements of the forming apparatus will be omitted in each following embodiment. As will be described later, the most significant differences in structural feature of the forming apparatus (printer) 10 according to the respective embodiments including this embodiment lie in the function of the data processing unit 12, so that the function of the data processing unit 12 will be mainly described in the following explanation.

Now, an operation of the printer 10 according to this embodiment and the three-dimensional image forming method of this embodiment will be described while also explaining the construction and function of the data processing unit 12a with reference to an operation flowchart of the printer 10 of this embodiment shown in FIG. 3A and a concrete construction of a data processing unit 12a shown in FIG. 3B corresponding to the data processing unit 12 of the printer 10 shown in FIG. 1.

As shown in FIG. 3B, in the printer 10 of this embodiment that carries out the forming method of this embodiment, first, the data processing unit 12a receives three-dimensional image data (information) as original data from a data supply source (hereinafter referred to as the “upper apparatus”) and extracts two-dimensional image data (information) and three-dimensional object information. Alternatively, the data processing unit 12a receives the two-dimensional image data and the three-dimensional object information as original data directly from the upper apparatus. Then, the data processing unit 12a performs data processing and outputs two-dimensional image data and height gradation data as output data. Accordingly, the data processing unit 12a includes an information extraction section 22 that receives three-dimensional data (information) as original data from the upper apparatus and extracts two-dimensional image data (information) and three-dimensional object information, a second information acquisition section 24 for extracting and acquiring second height information concerning the height of a three-dimensional object from the three-dimensional object information inputted from the upper apparatus or the information extraction section 22, and a first information conversion section 26 that converts the second height information obtained by the second information acquisition section 24 into height gradation data that is first height information.

In step 50, when data for which a three-dimensional image should be formed is inputted from the upper apparatus (in this example, it is assumed that three-dimensional image data is inputted as original data), the data processing unit 12a starts the processing shown in the flowchart in FIG. 3A. First, the information extraction section 22 extracts two-dimensional image information (data) and three-dimensional object information from the three-dimensional image data and sends the extracted two-dimensional image information to the control unit 14. Note that when the original data inputted from the upper apparatus into the data processing unit 12a is not the three-dimensional image data but is a pair of two-dimensional image information (data) and three-dimensional object information, the information extraction section 22 is bypassed. Therefore, in this case, the two-dimensional image information is directly sent to the control unit 14 and the three-dimensional object information is directly inputted into the information acquisition section 24.

Then, the control unit 14 activates each means of the recording target member transport unit 20 and the ink jet head 16a based on the inputted two-dimensional image information. As a result, predetermined printing is performed on a recording target member by the ink jet head 16a. For instance, a first layer image (two-dimensional image) is formed with ejected ink in a mode in which only ink is ejected from the ink jet head 16a.

Next, in step 52, the control unit 14 activates the first fixing section 18a and the first layer image formed on the recording target member by the ink jet head 16a is dried/fixed through fixation or preferably pressure fixation by the first fixing section 18a.

Following this, in step 54, in the data processing unit 12a, the three-dimensional object information extracted by the information extraction section 22 is inputted into the second information acquisition section 24, which then extracts second height information concerning the height of a three-dimensional object and conversion designation information accompanying the second height information as information concerning a material feeling from the input information (three-dimensional object information).

In step 56, the first information conversion section 26 performs conversion on the second height information extracted by the second information acquisition section 24 based on the accompanying conversion designation information. As a result, height gradation data that is the first height information is obtained. A concrete example of the contents of the conversion performed by the first information conversion section 26 will be described later.

It should be noted here that steps 54 and 56 may be executed after the extraction of the two-dimensional image information and the three-dimensional object information by the information extraction section 22 and before the formation of the first layer image in step 50. Also, preferably, these steps may be simultaneously executed in parallel with the formation of the first layer image and the fixation of the first layer image in step 52.

In step 58, the height gradation data obtained through the conversion by the first information conversion section 26 is sent to the control unit 14. Then, the control unit 14 activates each means of the recording target member transport unit 20 and the ink jet head 16b based on the height gradation data. As a result, predetermined printing on the first layer image formed with ink dried/fixed on the recording target member is performed by the ink jet head 16b based on the height gradation data obtained as a result of the conversion described above. For instance, a lamination image (three-dimensional image) is formed with solid particles in a mode in which jets containing the solid particles are ejected (discharged) from the ink jet head 16b.

Next, in step 60, the control unit 14 activates the second fixing section 18b and the three-dimensional image formed on the first layer image on the recording target member by the ink jet head 16b is heat-fixed through fixation or preferably by a heat-fixing section without effecting contact or applying pressure. As a result, an aimed three-dimensional image is formed.

In step 62, a print result is observed and it is checked whether a result as desired is obtained. When a result as desired is obtained, the processing is ended. On the other hand, if a result as desired is not obtained, the processing returns to step 56 and the conversion by the first information conversion section 26 is performed again. Alternatively, after an amendment or the like to conversion conditions is made, the conversion by the first information conversion section 26 is performed again. Then, in steps 58 and 60, another three-dimensional image is formed. In this manner, the operations in steps 56 to 62 are repeated until a result as desired is obtained.

In this manner, a three-dimensional image that is the final aim of the present invention is formed.

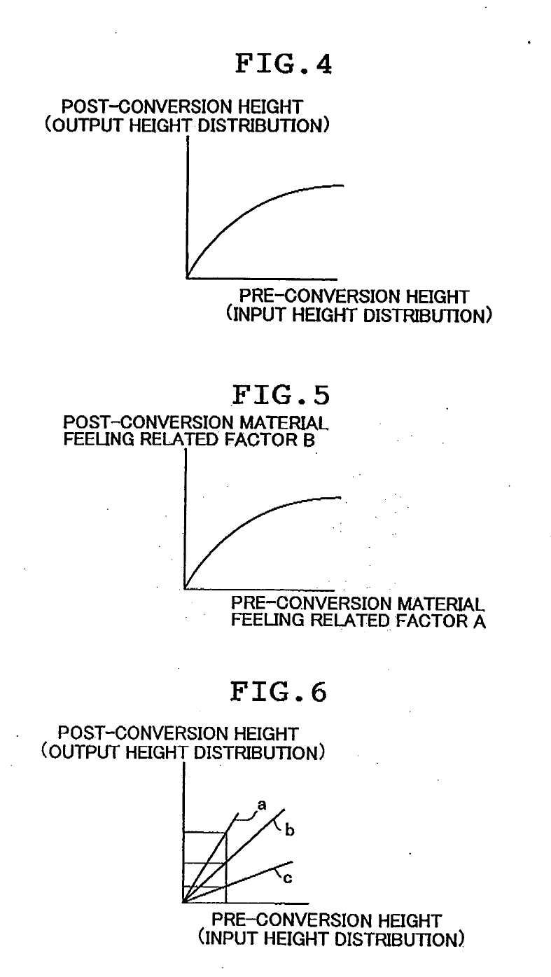

FIG. 4 shows an example of the height conversion described above, with the horizontal axis representing a pre-conversion height (that is, the height distribution of an input image) and the vertical axis indicating a post-conversion height (that is, the height distribution of an output image). In FIG. 4, there is shown an example where a range is compressed as a whole but a low-height portion of the input image (left-side portion in the graph) is enhanced. That is, in FIG. 4, there is performed conversion into characteristics where small undulation are enhanced but large undulation are compressed.

In the embodiment described above, an example has been described in which the height information is dealt with as information concerning a material feeling. However, various other kinds of information to be described below may be used as the information concerning a material feeling that is usable in the present invention.

In the first place, the drawing of a material feeling could be defined as the expression of visually real feeling (expressed as a material feeling, texture, or the like in usual cases) through combination of two-dimensional image information such as colors and sharpness, and three-dimensional (image) information ((image) information inherent in a three-dimensional object) such as undulation and reflection/scattering characteristics. That is, the drawing of a material feeling can be expressed as “three-dimensional object information (material feeling) (two-dimensional) image information +three-dimensional object inherent information”.

It is generally conceived that the drawing of a material feeling is performed (1) when precise duplication is performed, (2) when arbitrary changes (partial enhancement/compression) are performed, (3) when although the amount of information is small, enhancement is performed based on visual recognition characteristics, and (4) when a completely new material feeling is created, for instance. In the embodiment described above, the case (2) among the above where arbitrary changes are made has been described as an example.

Here, the (two-dimensional) image information described above includes color information (XYZ value, hue/saturation/brightness, dot ratio, and the like), gradation information, modulation characteristics (density modulation, area modulation (AM, FM), and the like), and image structure (sharpness, graininess, and the like).

Also, the three-dimensional object inherent information includes undulation information (height information (showing the maximum height and the minimum height, for instance), height resolution, the number of steps of the height gradation, and the like), undulation two-dimensional information (surface roughness, undulation gradation, undulation frequency distribution, directional properties, and the like), surface/interlayer optical characteristics (reflection factor/absorption factor, reflection directional properties (regular reflection and scattering), and the like), and information showing how multiple layers having two-dimensional information are overlaid on each other (color, gradation, modulation characteristics, image structure, layer inside structure, and the like).

FIG. 5 illustrates a concept of conversion of the three-dimensional object inherent information described above, with the horizontal axis representing a pre-conversion material feeling related factor A and the vertical axis indicating a post-conversion material feeling related factor B. In this drawing, an example is shown in which conversion between them is performed in a non-linear manner. As to an undulation feeling, there is a characteristic that an object in red is visually expanded and an object in blue is visually shrunk, so that it is possible to cite a case in which a conversion curve is changed in accordance with the color of an input image, as a concrete example.

In this case, it is required to analyze the influences of various material feeling related factors on how an observer feels a printed object and to define a favorable conversion method for each influence. The same applies to other material feeling related factors.

Other concrete examples will be described below.

FIGS. 6 to 16B each illustrate the details of the three-dimensional object inherent information whose examples have been described above.

First, FIG. 6 relates to conversion of height gradation, with the straight line b having an angle of 45° representing a conversion curve used in the case where precise reproduction (that is, duplication) is desired, the upper-side straight line a having a steep gradient indicating a conversion curve used in the case where it is desired to enhance the height gradation, and the lower-side straight line c having a gentle gradient representing a conversion curve used in the case where it is desired to compress the height gradation.

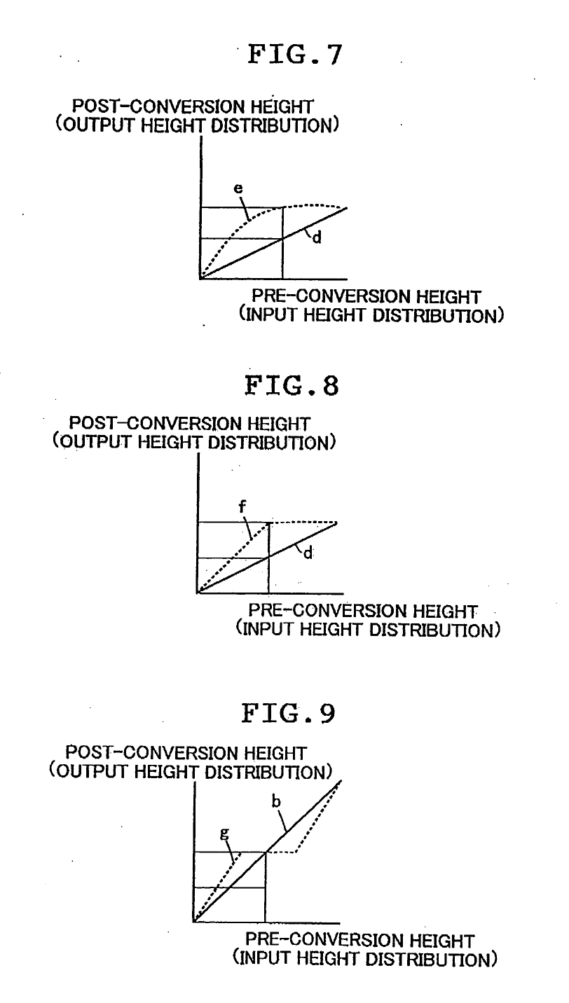

Also, FIG. 7 relates to a case where the height gradation is converted in a more complicated/multifarious manner, with an upwardly projecting curve e drawn using a broken line with respect to a basic curve d drawn using a solid line being a conversion curve used in the case where it is desired to enhance the height gradation at a low altitude. Also, in FIG. 8, an upwardly projecting bent line curve f is another conversion curve used in the case where it is desired to enhance the height gradation at a low altitude.

Further, FIG. 9 also relates to a case where the height gradation is converted in a still more complicated/multifarious manner. In this drawing, an S-letter-shaped bent line g is drawn using a broken line as distinguished from a basic curve (straight line having an angle of 45°) b, and represents a conversion curve used in the case where it is desired to enhance the height in a low altitude region and a high altitude region and to compress differences in height in a medium altitude region.

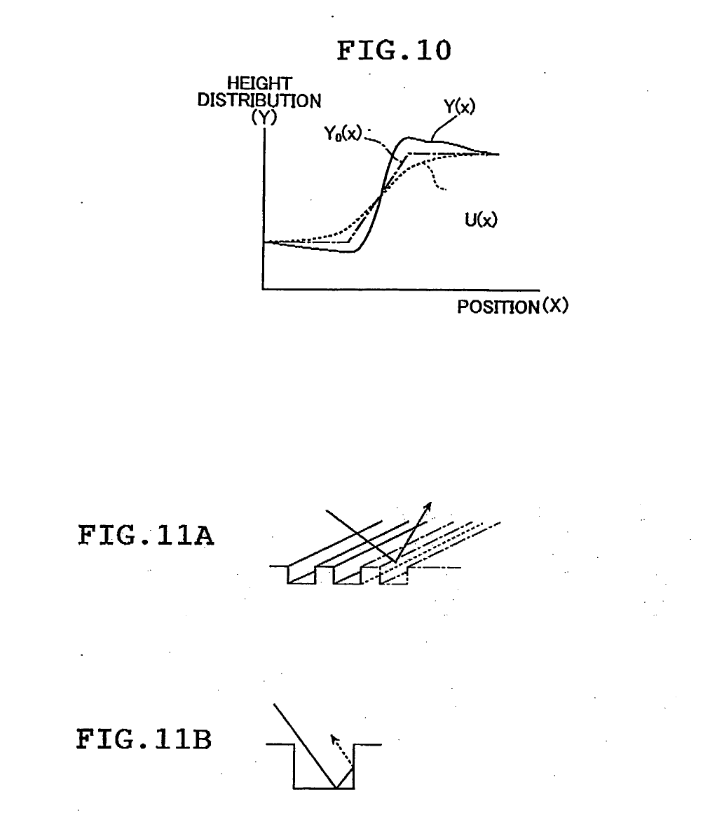

FIG. 10 shows an example of a conversion curve suited for a case where it is desired to enhance the height gradation. In this drawing, as an example, a case is shown in which the following processing is performed using a spatial filter (averaging mask).

Y(X)=Y₀(X)+K{Y₀(X)−U(X)) (1)

where Y₀

(X): pre-conversion height distribution

Y(X): height distribution after conversion processing

U(X): height distribution after averaging mask processing

K: constant.

That is, in FIG. 10, Y₀(X) denotes a pre-conversion height distribution, U(X) a height distribution in the case where the spatial filter composed of the averaging mask is applied to the pre-conversion height distribution, and Y(X) a post-processing height distribution obtained from Equation (1) given above using these data. In this manner, it is possible to enhance the height gradation in an arbitrary manner.

Up to this point, the height information has been considered. Next, description will be given to the availability of more general three-dimensional object inherent information whose examples are undulation two-dimensional information, the surface/interlayer optical characteristics, and the like.

FIGS. 11A and 11B each illustrate directional properties that are an example of the two-dimensional information of the undulation (projection/depression), FIG. 11A is a perspective view showing a schematic configuration of a directional property that is an example of the light and grooves and FIG. 11B is a sectional view showing a schematic configuration of a directional property that is another example of the light and groove.

FIGS. 11A and 11B each illustrate the behavior of light incident on a surface having many grooves, with FIG. 11A showing the behavior of light incident parallel to the grooves and FIG. 11B showing the behavior of light incident perpendicular to the grooves. As shown in FIG. 1A, the light incident parallel to the grooves is reflected and emerges from the grooves as it is. On the other hand, as shown in FIG. 11B, the light incident perpendicular to the grooves is repeatedly reflected in the grooves and is hardly captured by the grooves. By taking such characteristics into consideration at the time of conversion, it becomes possible to adjust a three-dimensional image to be formed in various manners.

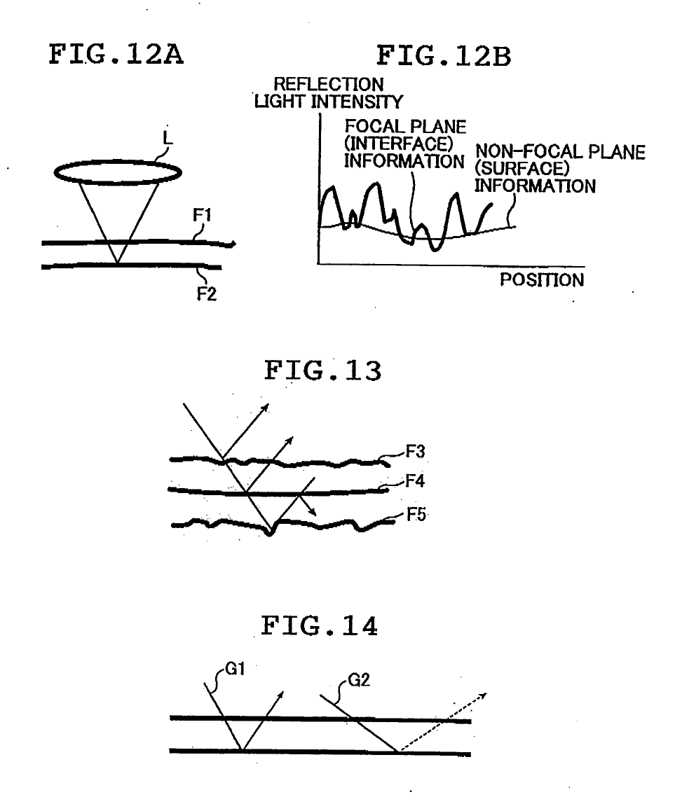

FIGS. 12A to 16B are each an explanatory diagram of processing of information concerning surface/interlayer optical characteristics

In more detail, FIGS. 12A and 12B are each an explanatory schematic diagram of a method for separating surface information and interface information in a three-dimensional object produced by forming a film on a support. Particularly, FIG. 12B illustrates schematically the surface information and the interface information separated from each other by the separation method shown in FIG. 12A.

In FIG. 12A, “L” denotes a lens, “F1” a surface of a lamination member, “F2” a surface of the support that is an interface and serves as a focal plane. In this case, if the lens L is focused on the focal plane F2, it is of course possible to obtain information of the focused portion, but it is also possible to obtain the information of the surface F1 of the lamination member thereon to some extent if a different frequency filter is used (see FIG. 12B).

FIG. 13 is an explanatory diagram of a method for separating scattering characteristics of surfaces and scattering characteristics of an interface in a layered three-dimensional object (lamination member). In FIG. 13, “F3” denotes a surface of a lamination member having large undulation, “F4” a smooth interface, and “F5” a surface (interface) of a support. In the case of such a lamination member, it is required to give consideration to the reflection at both of the front and back surfaces of the smooth interface F4 and the reflection at the support surface F5 as well as the reflection at the surface F3.

FIG. 14 is an explanatory diagram of the incident angle dependency of a light absorption factor of a film (layer) in a three-dimensional object produced by forming a film on a support. In FIG. 14, “G1” denotes a reflection state of light incident at a relatively acute angle, while “G2” indicates a reflection state of light incident at a relatively obtuse angle. As can be seen from this drawing, even if light is incident on the same layer, the quantity of light emitted varies depending on its incident angle, so that it is required to give consideration to this fact at the time of data conversion.

FIG. 15 is an explanatory diagram of the influence of a size distribution of resin particles in a lamination member composed of layers containing the resin particles. In this drawing, “S1” denotes an uppermost layer that is a layer in which a resin grain structure has been lost due to heat-fixation processing, “S2” a layer in which the resin grain structure (having small diameters) is left, and “S3” a layer in which the resin grain structure (having large diameters) is left. If the structure information of the layers (lamination layer information) is dealt with together with information concerning the packing states of the respective layers, the availability of the three-dimensional object inherent information is improved.

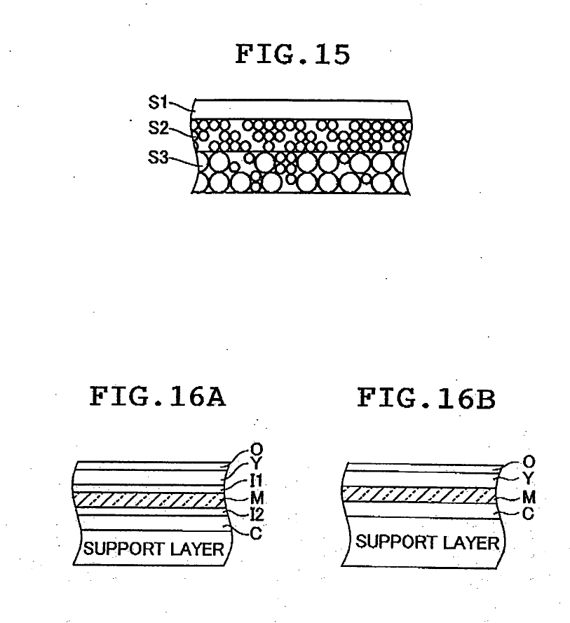

FIGS. 16A and 16B are each an explanatory diagram showing a case where a difference in the transparency of a three-dimensional image to be formed occurs in accordance with whether intermediate layers are inserted when multiple layers are overlaid on each other, and are a transparent color three-dimensional image having the intermediate layers and a color three-dimensional image having no intermediate layer, respectively. In more detail, FIG. 16A shows a case where in a color three-dimensional image composed of coloring layers in three colors that are Y (yellow), M (magenta), and C (cyan) as well as a transparent protective layer O, transparent intermediate layers I1 and I2 are inserted between the coloring layers. On the other hand, FIG. 16B shows a case where the intermediate layers are not inserted.

By giving consideration to the layer structure described above at the time of formation of a three-dimensional image, it becomes possible to form a desired three-dimensional image suited for a purpose.

Here, needless to say, there is a case where it is possible to form a more effective three-dimensional image by combining the various kinds of three-dimensional object inherent information described above together as appropriate.

By the way, in the first embodiment, description has been made by assuming that three-dimensional image data or a pair of two-dimensional image data and three-dimensional object information is inputted from the upper apparatus to the data processing unit 12 (12a) as original data for which a three-dimensional image should be formed. Next, a second embodiment that is an application example of the present invention will be described in which only two-dimensional image data is used as the input data.

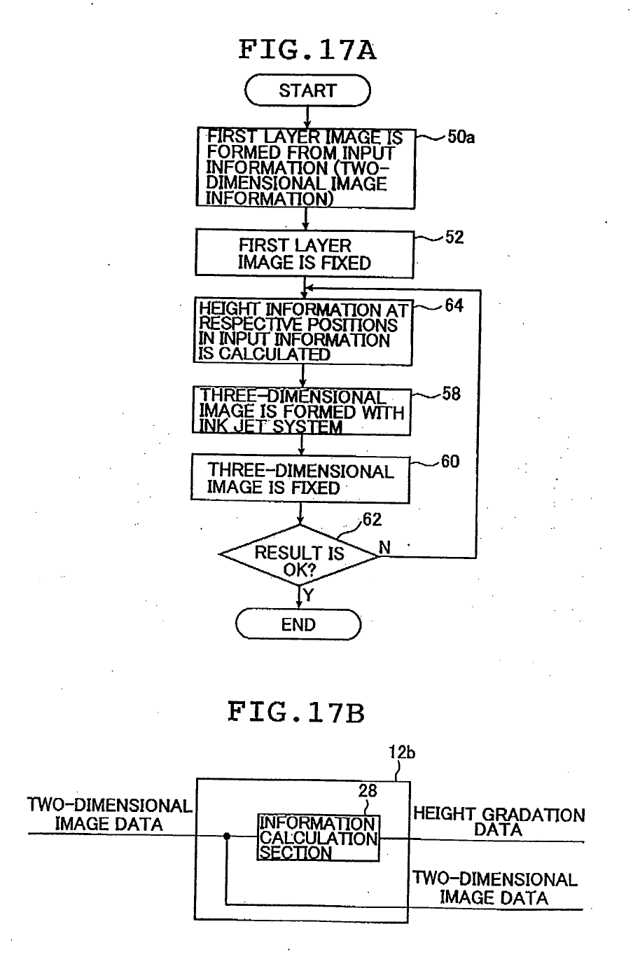

FIG. 17A is a flowchart illustrating the outline of an operation example of the second embodiment of the present invention in the case where the aforementioned three-dimensional image forming apparatus 10 according to the embodiment shown in FIGS. 1 and 2 is used. Also, FIG. 17B is a block diagram showing a concrete construction of the second embodiment of the data processing unit 12 of the printer 10 shown in FIG. 1.

The characteristic operation of the printer 10 according to this second embodiment and the three-dimensional image forming method of the second embodiment will be described based on the operation flowchart shown in FIG. 17A and the data processing unit 12b of the second embodiment shown in FIG. 17B.

First, as shown in FIG. 17B, in the printer 10 of the second embodiment that implements the forming method of the second embodiment, the data processing unit 12b receives two-dimensional image data (information) as original data from the upper apparatus, calculates height gradation data corresponding to a three-dimensional object, and outputs the two-dimensional image data and the height gradation data as output data. Accordingly, the data processing unit 12b includes a first information calculation section 28 that receives the two-dimensional image data (information) from the upper apparatus as the original data and calculates the height gradation data that is first height information from the two-dimensional image data (information).

It should be noted here that the flowchart shown in FIG. 17A has the same step structure as that in FIG. 3A except that steps 50a and 64 are included instead of steps 50, 54, and 56. Therefore, the same steps as in FIG. 3A are given the same reference numerals and the detailed description thereof will be omitted.

In step 50a, when data, for which a three-dimensional image should be formed, is inputted from the upper apparatus (in this embodiment, two-dimensional image data (information) is inputted as the original data), the two-dimensional image information is sent to the control unit 14 and a first layer image (two-dimensional image) is formed on a recording target member by the ink jet head 16a controlled by the control unit 14, like in step 50.

In step 52, the first layer image formed on the recording target member in this manner is fixed and secured by the first fixing section 18a.

In this embodiment, the original data inputted from the upper apparatus is the two-dimensional image data, as described above. Therefore, in step 64, the data processing unit 12b first calculates height gradation data, which is the first height information described above, for image information at respective positions (practically, it is sufficient that some of the positions are selected) in the input information (two-dimensional image data).

For instance, it is possible to execute this calculation step 64 using a system where a target object (three-dimensional object) is clipped from the two-dimensional image data with a known image processing method and height assignment is performed in accordance with the target object (for instance, a person in a foreground, a background landscape, or the like). Alternatively, for instance, it is possible to execute this step 64 by designating positions, requesting an operator to input height information corresponding to the positions, and using the inputted data.

In step 58, the height gradation data obtained as a result of the calculation by the first information calculation section 28 is sent from the data processing unit 12b to the control unit 14. Then, the control unit 14 controls the ink jet head 16b based on the height gradation data so that a lamination image (three-dimensional image) is formed with ink solid on the first layer image on the recording target member.

In step 60, the three-dimensional image formed on the first layer image on the recording target member in this manner is fixed by the second fixing section 18b and an aimed three-dimensional image is obtained.

In step 62, a print result is checked. If a result as desired is obtained, the processing is ended; if not, the operations in steps 64, 58, 60, and 62 are repeated until a result as desired is obtained.

In this manner, a three-dimensional image that is the final aim of the present invention is formed.

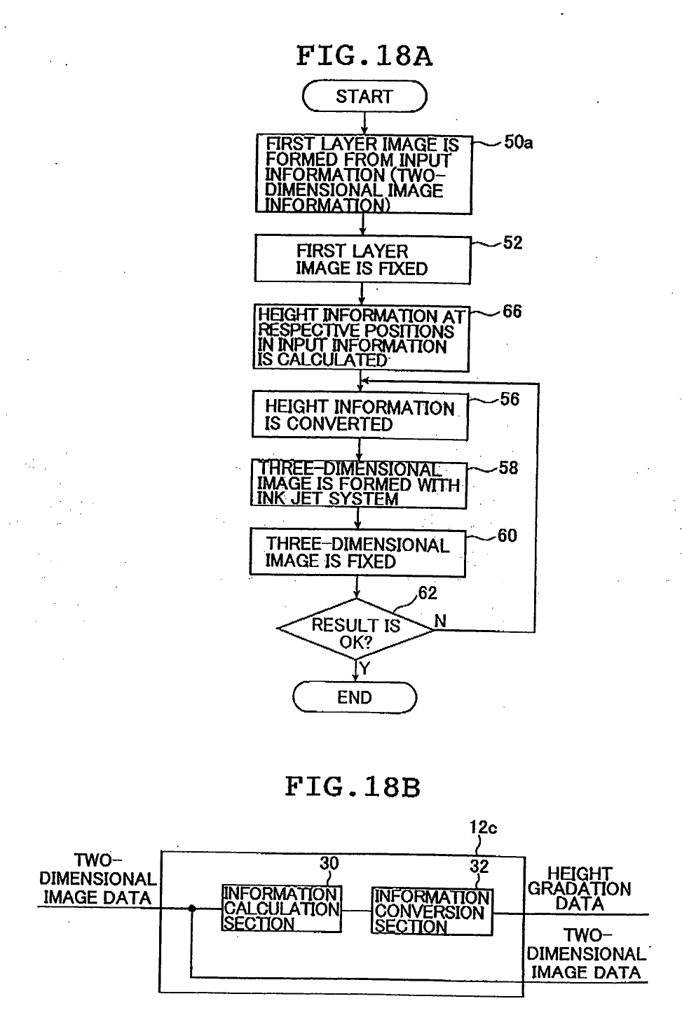

Here, in this second embodiment shown in FIG. 17A, the first height information is directly calculated in step 64 and is used as it is. However, in a third embodiment shown in FIG. 18A, third height information concerning the height of a three-dimensional object in a first layer image on a recording target member is calculated in step 66 and is converted once using the conversion method described above into height gradation data that is the first height information to be applied to the formation of a lamination image. With this construction, it becomes possible to reproduce desired characteristics by selecting an appropriate method from among the various conversion methods described above.

As shown in FIG. 18B, a data processing unit 12c used in the third embodiment as the data processing unit 12 of the printer 10 has a function of receiving two-dimensional image data and sending it to the control unit 14 as it is as two-dimensional image information and includes a second information calculation section 30 that calculates third height information concerning the height of a three-dimensional object in a first layer image on a recording target member from the inputted two-dimensional image data and a second information conversion section 32 that converts the third height information into height gradation data that is the first height information.

According to these second and third embodiments, there is produced an effect that it becomes possible to form a pseudo three-dimensional image with ease even if input image information does not include three-dimensional information such as three-dimensional image data or three-dimensional object information.

Next, a three-dimensional image forming method according to a third aspect of the present invention and a three-dimensional image forming apparatus according to a fourth aspect of the present invention will be described with reference to FIGS. 1, 2, and 19A to 22B.

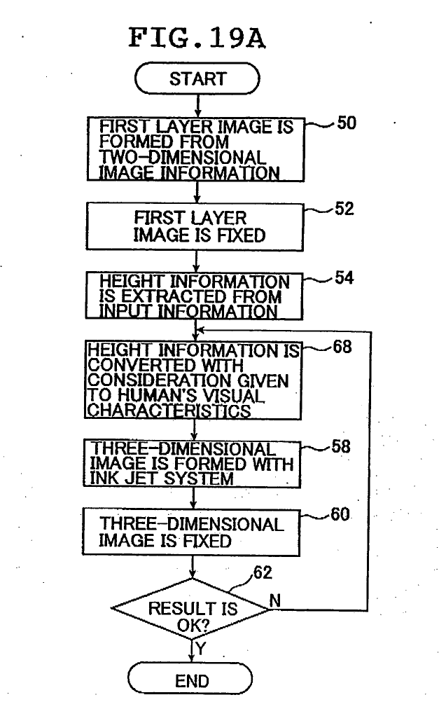

As described above, it is possible to use the three-dimensional image forming apparatus 10 shown in FIGS. 1 and 2 also in each embodiment of the forming method of the third aspect and the forming apparatus of the fourth aspect by changing the internal construction of the data processing unit. Therefore, the description thereof will be omitted and respective embodiments shown in FIGS. 19A to 22B will be mainly described.

FIG. 19A is a flowchart illustrating an operation in the case where the forming apparatus 10 according to the embodiment shown in FIGS. 1 and 2 is used, that is, the outline of a first embodiment of the forming method of the third aspect of the present invention. Also, FIG. 19B shows a schematic construction of a first embodiment of a data processing unit of the forming apparatus of the fourth aspect of the present invention used in the forming method of the first embodiment, and is a block diagram showing a concrete construction of a data processing unit 12 in this embodiment of the printer 10 shown in FIG. 1.

In the following description, there will be explained an operation of the printer 10 according to this embodiment and the three-dimensional image forming method of this embodiment while also describing the construction and function of the data processing unit 12d based on the operation flowchart of the printer 10 of this embodiment shown in FIG. 19A and the data processing unit 12d shown in FIG. 19B.

It should be noted here that the flowchart shown in FIG. 19A has the same step structure as that in FIG. 3A except that step 68 is included instead of step 56. Therefore, the same steps as in FIG. 3A are given the same reference numerals and the detailed description thereof will be omitted. Also, the data processing unit 12d shown in FIG. 19B has the same construction as the data processing unit 12a shown in FIG. 38 except that a third information conversion section 34 is provided instead of the first information conversion section 26. Therefore, the same construction elements are given the same reference numerals and the detailed description thereof will be omitted.

First, as shown in FIG. 19B, in the printer 10 of this embodiment that implements the forming method of this embodiment, the data processing unit 12d receives three-dimensional image data (information) as original data from the upper apparatus and extracts two-dimensional image data (information) and three-dimensional object information. Alternatively, the data processing unit 12d receives the two-dimensional image data and the three-dimensional object information as original data directly from the upper apparatus. Then, the data processing unit 12d obtains height information from the three-dimensional object information. Following this, the data processing unit 12d obtains height gradation data by changing the height information based on human's visual characteristics and outputs the two-dimensional image data and the height gradation data as output data.

Here, the data processing unit 12d includes: an information extraction section 22 that receives the three-dimensional image data (information) as original data from the upper apparatus and extracts the two-dimensional image data (information) and the three-dimensional object informations a second information acquisition section 24 that extracts and acquires second height information concerning the height of a three-dimensional object from the three-dimensional object information inputted from the upper apparatus or the information extraction section 22; and a third information conversion section 34 that converts the second height information obtained by the second information acquisition section into height gradation data that is the first height information based on the human's visual characteristics.

That is, in order to obtain the height gradation data that is the first height information, the first information conversion section 26 shown in FIG. 3B converts the second height information so that reproduction with desired height information is possible, although the third information conversion section 34 shown in FIG. 19B performs conversion based on the human's visual characteristics.

In step 50, when data (three-dimensional image data), for which a three-dimensional image should be formed, is inputted from the upper apparatus, the information extraction section 22 in the data processing unit 12a extracts two-dimensional image information (data) and three-dimensional object information from the three-dimensional image data. Then, the extracted (or directly inputted) two-dimensional image information is sent to the control unit 14. Based on the two-dimensional image information, the control unit 14 controls the ink jet head 16a so that a first layer image (two-dimensional image) is formed on a recording target member.

In step 52, the first layer image formed on the recording target member in this manner is fixed and secured by the first fixing section 18a.

On the other hand, in step 54, in the data processing unit 12a, the three-dimensional object information extracted by the information extraction section 22 or directly inputted is inputted into the second information acquisition section 24. In the second information acquisition section 24, as information concerning a material feeling, second height information concerning the height of the three-dimensional object described above and conversion designation information accompanying this information are extracted from the input information (three-dimensional object information)

In step 68, conversion of the second height information extracted by the second information acquisition section 24 is performed by the third information conversion section 34 based on the accompanying conversion designation information and the human's visual characteristics. In this manner, height gradation data that is the first height information is obtained. A concrete example of the conversion designation contents and the human's visual characteristics will be described later.

It should be noted here that these steps 54 and 68 may be executed after the extraction of the two-dimensional image information and the three-dimensional object information by the information extraction section 22 and before the formation of the first layer image in step 50. Also, preferably, these steps may be simultaneously executed in parallel with the formation of the first layer image and the fixation of the first layer image in step 52.

In step 58, the height gradation data obtained as a result of the calculation by the third information conversion section 34 is sent from the data processing unit 12d to the control unit 14. Then, the control unit 14 controls the ink jet head 16b based on the height gradation data so that a lamination image (three-dimensional image) is formed with ink solid on the first layer image on the recording target member.

In step 60, the three-dimensional image formed on the first layer image on the recording target member in this manner is fixed by the second fixing section 18b and an aimed three-dimensional image is obtained.

In step 62, a print result is checked. If a result as desired is obtained, the processing is ended; if not, the operations in steps 68, 58, 60, and 62 are repeated until a result as desired is obtained.

In this manner, a three-dimensional image that is the final aim of the present invention is formed.

Next, a concrete example of the conversion designation contents and the human's visual characteristics will be described.

It should be noted here that also in this embodiment, the aforementioned various kinds of material feeling drawing, such as the height conversion shown in FIG. 4, are applicable as the conversion designation contents. In this embodiment, in particulars, the case (3), in which enhancement based on the visual recognition characteristics is performed, out of the aforementioned cases (1) to (4) of the material feeling drawing will be described as an example.

Here, the function of binocular stereopsis will be described as a representative example of the human's visual characteristics on which the most striking feature of this embodiment is based.

The binocular stereopsis function is usually evaluated based on depth sensitivity. That is, by changing the parallax, there is obtained the minimum parallax amount required for depth detection. A threshold value of this parallax is called “stereoscopic acuity” and the acuity will be enhanced as this value is decreased.

It is known that the stereoscopic acuity described above is influenced by many stimulus variables. Also, by many researchers, the spatial frequency characteristics of the depth sensitivity have been measured using a technique with which a threshold value that enables the detection of a depth is measured by changing the parallax using a sine-wave-like curve stimulus.

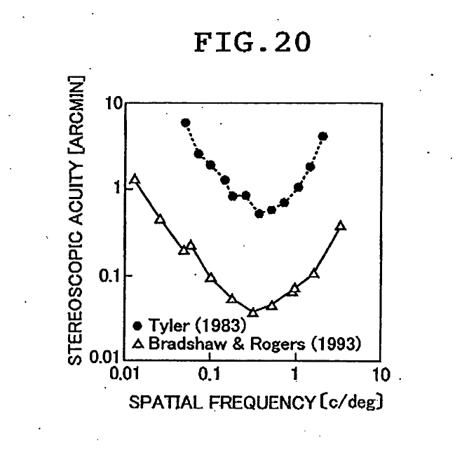

By way of example, FIG. 20 shows a part of results of measurement conducted by Tyler and by Bradshaw and Rogers. A remarkable point in this drawing is that in either measurement result, the maximum sensitivity exists in the vicinity of 0.3 to 1 cycle/deg.

Therefore, the application of this characteristic to the height information conversion is conceivable. For instance, when height information in three-dimensional shape information is converted based on the human's visual characteristics, it is conceived that a system where a height frequency is determined based on the characteristic described above, a system where a height gradation is converted in accordance with a height resolution visibility curve, or the like is effective.

In more detail, it is conceived that the grainy feeling, the glossy feeling, or the like, which is to be felt with the human's sense of sight, obtained using samples having different surface roughness follows the characteristic described above. Therefore, when it is desired to enhance these feelings, it is conceived that the height frequency is set in the spatial frequency range described above.

It should be noted here that inclusive of the case where consideration is given to the human's visual characteristics described above, as to the conversion of the various kinds of three-dimensional object inherent information, the material feeling related factor conversion shown in FIGS. 5 to 16 described in the first embodiment of the first and second aspects is applicable also to this embodiment so that the description thereof will be omitted.

By the way, in this first embodiment, description has been made by assuming that three-dimensional image data, for which a three-dimensional image should be formed, or a pair of two-dimensional image data and three-dimensional object information is inputted from the upper apparatus to the data processing unit 12 (12e). Needless to say, however, like in the first and second aspects, the present invention is applicable also to a case where the input data is two-dimensional image data.

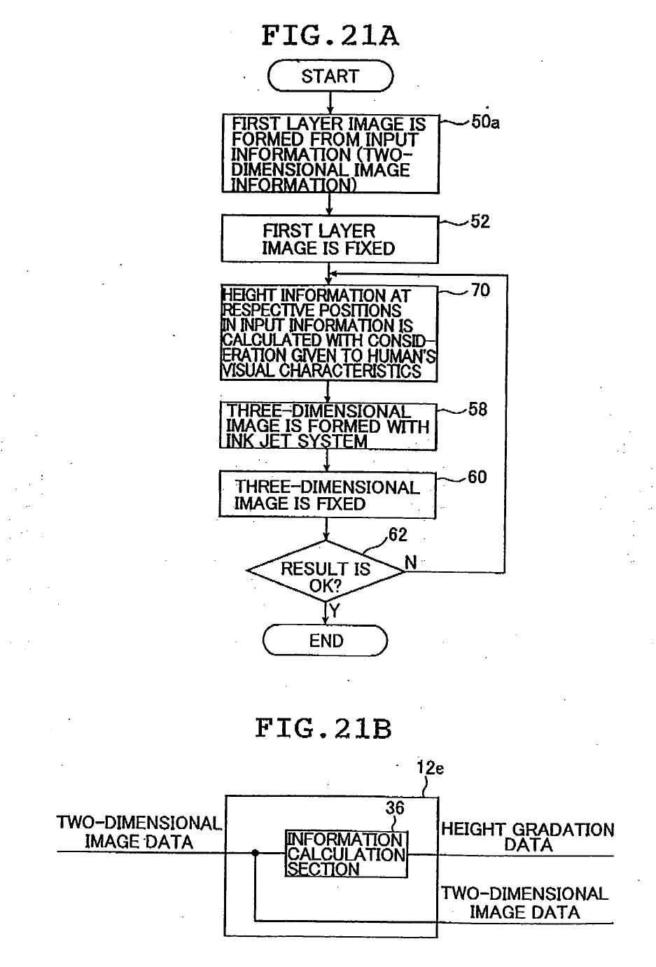

FIG. 21A is a flowchart illustrating the outline of an operation example of a second embodiment of this aspect in the case where the aforementioned three-dimensional image forming apparatus 10 according to the embodiment shown in FIGS. 1 and 2 is used. Also, FIG. 21B is a block diagram showing a concrete construction of a second embodiment of the data processing unit 12 of the printer 10 shown in FIGS. 1 and 2.

The characteristic operation of the printer 10 according to this second embodiment and the three-dimensional image forming method of the second embodiment will be described based on the operation flowchart shown in FIG. 21A and a data processing unit 12e of the second embodiment shown in FIG. 21B.

It should be noted here that the flowchart shown in FIG. 21A has the same step structure as that in FIG. 17A except that step 70 is included instead of step 64. Therefore, the same steps as in FIG. 17A are given the same reference numerals and the detailed description thereof will be omitted. Also, the data processing unit 12e shown in FIG. 21B has the same construction as the data processing unit 12b shown in FIG. 17B except that a third information calculation section 36 is provided instead of the second information conversion section 28. Therefore, the same construction elements are given the same reference numerals and the detailed description thereof will be omitted.

First, as shown in FIG. 21B, in the printer 10 of this second embodiment that implements the forming method of the second embodiment, the data processing unit 12e receives two-dimensional image data (information) as original data from the upper apparatus, calculates height gradation data corresponding to a three-dimensional object with consideration given to the human's visual characteristics, and outputs the two-dimensional image data and the height gradation data as output data. Accordingly, the data processing unit 12e includes a third information calculation section 36 that receives the two-dimensional image data (information) as original data from the upper apparatus and calculates the height gradation data that is the first height information from the two-dimensional image data (information).

That is, at the time when the height gradation data that is the first height information is obtained, the second information conversion section 28 shown in FIG. 178 performs conversion so that reproduction with desired height information is possible, although the third information calculation section 36 shown in PIG. 21B performs conversion based on the human's visual characteristics.

In step 50a, two-dimensional image data (information) inputted from the upper apparatus into the data processing unit 12e is sent to the control unit 14 and a first layer image (two-dimensional image) is formed on a recording target member by the ink jet head 16a controlled by the control unit 14.

In step 52, the first layer image formed on the recording target member in this manner is fixed and secured by the first fixing section 18a.

In this embodiment, the original data inputted from the upper apparatus is the two-dimensional image data. Therefore, in step 70, the data processing unit 12b calculates height gradation data that is the first height information described above for image information at respective positions (practically, it is sufficient that some of the positions are selected) in the input information (two-dimensional image data) with consideration given to the human's visual characteristics described above.

In this calculation step 70, it is possible to calculate the first height information in the same manner as in the calculation step 64 described above except that consideration is given to the human's visual characteristics.

In step 58, the height gradation data obtained as a result of the calculation by the third information calculation section 36 is sent from the data processing unit 12e to the control unit 14. Then, a lamination image (three-dimensional image) is formed with ink solid on the first layer image on the recording target member by the ink jet head 16b controlled by the control unit 14 based on the height gradation data.

In step 60, the three-dimensional image formed on the first layer image on the recording target member in this manner is fixed by the second fixing section 18b and an aimed three-dimensional image is obtained.

In step 62, a print result is checked. If a result as desired is obtained, the processing is ended; if not, the operations in steps 70, 58, 60, and 62 are repeated until a result as desired is obtained.

In this manner, a three-dimensional image that is the final aim of the present invention is formed.

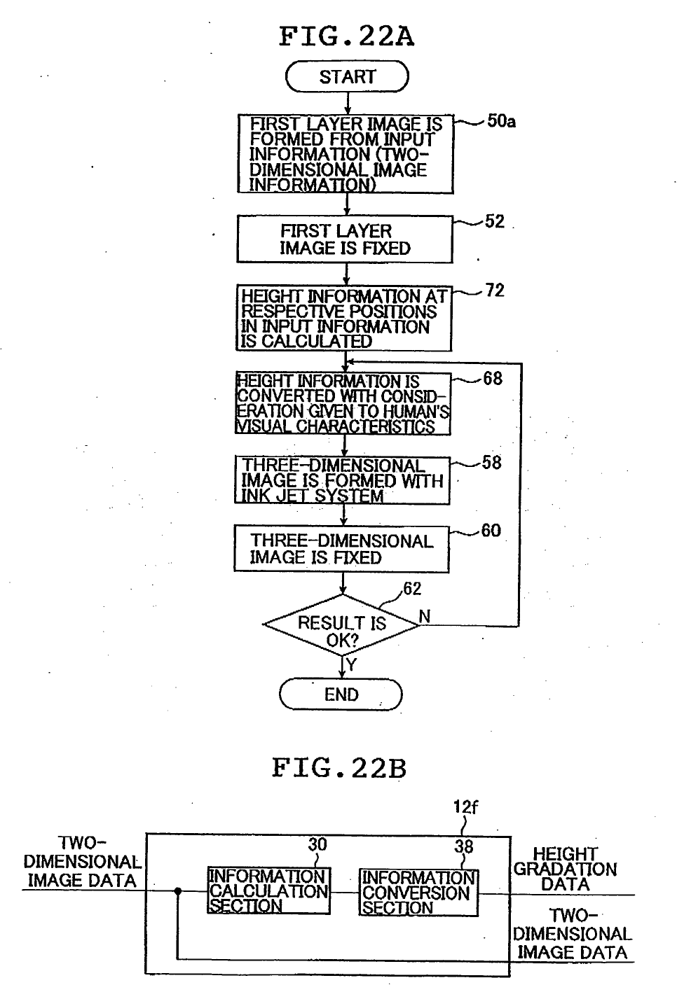

Here, in the second embodiment shown in FIG. 21A, the first height information is directly calculated in step 70 and is used as it is. However, in a third embodiment shown in FIG. 22A, third height information concerning the height of a three-dimensional object in a first layer image on a recording target member is calculated in step 72 and is converted once using the conversion method described above into height gradation data that is the first height information to be applied to the formation of a lamination image. With this construction, it becomes possible to reproduce desired characteristics by selecting an appropriate method from among the various conversion methods described above.

As shown in FIG. 22B, a data processing unit 12f used in the third embodiment as the data processing unit 12 of the printer 10 has a function of receiving two-dimensional image data and sending it to. the control unit 14 as it is as two-dimensional image information and includes a second information calculation section 30 that calculates third height information concerning the height of a three-dimensional object in a first layer image on a recording target member from the inputted two-dimensional image data and a fourth information conversion section 38 that converts the third height information into height gradation data that is the first height information.

According to these second and third embodiments, there is produced an effect that it becomes possible to form a pseudo three-dimensional image with ease even if input image information does not include three-dimensional information, such as three-dimensional image data or three-dimensional object information, or height information.

As described in detail above, according to the present invention, there is produced a prominent effect that it becomes possible to realize a three-dimensional image forming method and apparatus based on an ink jet system, with which it is possible to form a relief image that is a three-dimensional image having a desired and controlled height gradation corresponding to a desired three-dimensional shape on a first layer image formed on a support.

In more detail, according to the first and second aspects of the present invention, there is produced a practical effect that it is possible to realize a three-dimensional image forming method and apparatus based on an ink jet system, with which it is possible to form a relief image that is a three-dimensional image having a desired height gradation corresponding to a three-dimensional shape owing to the following structures. The height information of a three-dimensional object in three-dimensional object information, such as inputted three-dimensional shape information, is converted into height information with which it is possible to reproduce desired height information, that is, undulation corresponding to the three-dimensional object, and a three-dimensional image is formed on a support based on the height information obtained as a result of the conversion. In addition, desired height information, with which it is possible to reproduce undulation corresponding to the three-dimensional object and corresponding to at least some of positions on a two-dimensional image, is calculated from inputted two-dimensional image information and the three-dimensional image is formed on the support based on the calculated height information.

In more detail, according to the third and fourth aspects of the present invention, there is produced a practical effect that it is possible to realize a three-dimensional image forming method and apparatus based on an ink jet system, with which it is possible to form a relief image that is a three-dimensional image having a desired height gradation corresponding to a three-dimensional shape owing to the following structures, The height information of a three-dimensional object in three-dimensional object information, such as inputted three-dimensional shape information, is converted, while giving consideration to the human's visual characteristics, into height information with which it is possible to reproduce, or preferably express accurately, desired height information, that is, undulation corresponding to the three-dimensional object. Then, a three-dimensional image is formed on a support based on the height information obtained as a result of the conversion. In addition, desired height information, with which it is possible to reproduce undulation corresponding to the three-dimensional object and corresponding to at least some of positions on a two-dimensional image, is calculated, while giving consideration to the human's visual characteristics, from inputted two-dimensional image information and the three-dimensional image is formed on the support based on the calculated height information.

It should be noted here that the embodiments described above are each merely an example of the present invention and there is no intention to limit the present invention to the embodiments. That is, it is of course possible to make modifications and changes as appropriate without departing from the gist of the present invention.

For instance, in the embodiments described above, the forming method based on the ink jet system has been described as a concrete example of the three-dimensional image forming method, but the present invention is not limited to this.

What is claimed is:

1. A three-dimensional image forming method for forming a three-dimensional image having undulation corresponding to a three-dimensional object on a support using an ink jet system, comprising:
forming as a two-dimensional image a first layer image including said three-dimensional object on said support based on two-dimensional image information;
securing said first layer image on said support;
acquiring first height information with which said undulation corresponding to said three-dimensional object are reproducible on said support;
forming a lamination image of said three-dimensional image having said undulation corresponding to said three-dimensional object by laminating ink solid ejected using said ink jet system on said first layer image secured on said support based on said acquired first height information; and
fixing said lamination image of said three-dimensional image formed on said first layer image and having said undulation corresponding to said three-dimensional object.

2. The three-dimensional image forming method according to claim 1, wherein said first layer image is formed using an ink jet system that is the same as or different from said ink jet system used to form said lamination image of said three-dimensional image.

3. The three-dimensional image forming method according to claim 1, wherein
said lamination image of said three-dimensional image is formed using an ink jet system that is capable of laminating said ink solid by ejecting ink containing a thermoplastic solid or ultraviolet cure ink, and said first layer image is formed using an ink jet system that is capable of forming a two-dimensional image by ejecting water-based ink, oil-based ink or ultraviolet cure ink for image recording.

4. The three-dimensional image forming method according to claim 1, wherein first fixation processing performed to secure said first layer image on said support and second fixation processing performed to fix said lamination image of said three-dimensional image formed on said first layer image are different from each other.

5. The three-dimensional image forming method according to claim 1, wherein said step of acquiring said first height information comprises the steps of:
acquiring second height information concerning a height of said three-dimensional object from inputted three-dimensional object information; and
converting the acquired second height information into desired height information with which said undulation corresponding to said three-dimensional object are reproducible on said support as said first height information.

6. The three-dimensional image forming method according to claim 5, wherein
said three-dimensional object information includes three-dimensional shape information concerning said three-dimensional object, and
said second height information is information concerning a height in said three-dimensional shape information.

7. The three-dimensional image forming method according to claim 5, wherein said two-dimensional image information is two-dimensional image data inputted in addition to said three-dimensional object information.

8. The three-dimensional image forming method according to claim 5, wherein said two-dimensional image information and said three-dimensional object information are acquired from said inputted three-dimensional image information.

9. The three-dimensional image forming method according to claim 1, wherein
said two-dimensional image information is inputted information, and
said step of acquiring said first height information comprises the step of:
calculating as said first height information desired height information, with which said undulation corresponding to said three-dimensional object and corresponding to at least one part of positions on said first layer image are reproducible on said support, from the inputted two-dimensional image information.

10. The three-dimensional image forming method according to claim 1, wherein
said two-dimensional image information is inputted information, and
said step of acquiring said first height information comprises the steps of:
calculating third height information corresponding to at least one part of positions on said first layer image from the inputted two-dimensional image information; and
converting the calculated third height information into desired height information with which said undulation corresponding to said three-dimensional object are reproducible on said support as said first height information.

11. The three-dimensional image forming method according to claim 1, wherein said step of acquiring said first height information comprises the steps of:
acquiring second height information concerning a height of said three-dimensional object from inputted three-dimensional object information, and
converting the acquired second height information based on human's visual characteristics into desired height information with which said undulation corresponding to said three-dimensional object are reproducible on said support.

12. The three-dimensional image forming method according to claim 11, wherein
said three-dimensional object information includes three-dimensional shape information concerning said three-dimensional object, and
said second height information is information concerning a height in said three-dimensional shape information.

13. The three-dimensional image forming method according to claim 11, wherein said two-dimensional image information is two-dimensional image data inputted in addition to said three-dimensional object information.

14. The three-dimensional image forming method according to claim 11, wherein said two-dimensional image information and said three-dimensional object information are acquired from inputted three-dimensional image information.

15. The three-dimensional image forming method according to claim 11, wherein said step of converting said second height information based on the human's visual characteristics comprises the step of:
determining a height frequency based on a grainy feeling or a glossy feeling, which is to be felt with human's sense of sight, obtained using samples having different surface roughness.

16. The three-dimensional image forming method according to claim 11, wherein said step of converting said second height information based on the human's visual characteristics comprises the step of:
converting a height gradation in accordance with a height resolution visibility curve.

17. The three-dimensional image forming method according to claim 16, wherein said step of converting said height gradation in accordance with said height resolution visibility curve is performed so that selective enhancement or suppression is performed in a region in which said human's sense of sight is enhanced.

18. The three-dimensional image forming method according to claim 16, wherein said step of converting said height gradation in accordance with said height resolution visibility curve is performed so that information cut is performed in a region in which said human's sense of sight loses substantial sensitivity.

19. The three-dimensional image forming method according to claim 1,
wherein said two-dimensional image information is inputted information, and
said step of acquiring said first height information comprises the step of:
calculating desired height information, with which said undulation corresponding to said three-dimensional object and corresponding to at least one part of positions on said first layer image are reproducible on said support, from said inputted two-dimensional image information based on human's visual characteristics.

20. The three-dimensional image forming method according to claim 1, wherein
said two-dimensional image information is inputted information, and
said step of acquiring said first height information comprises the steps of:
calculating third height information corresponding to at least one part of positions on said first layer image from said inputted two-dimensional image information, and
converting the thus calculated third height information based on human's visual characteristics into desired height information with which said undulation corresponding to said three-dimensional object are reproducible on said support.

21. A three-dimensional image forming apparatus for forming a three-dimensional image having undulation corresponding to a three-dimensional object on a support using an ink jet system, comprising:
first forming means for forming as a two-dimensional image a first layer image including said three-dimensional object on said support based on two-dimensional image information;
securing means for securing said first layer image on said support;
first information acquiring means for acquiring first height information with which said undulation corresponding to said three-dimensional object are reproducible on said support;
second forming means for forming a lamination image of said three-dimensional image having said undulation corresponding to said three-dimensional object by laminating ink solid ejected using said ink jet system on said first layer image secured on said support based on the acquired first height information; and
a fixing means for fixing said lamination image of said three-dimensional image formed on said first layer image and having said undulation corresponding to said three-dimensional object.

22. The three-dimensional image forming apparatus according to claim 21, wherein said first forming means and said second forming means are each an ink jet head using a same or different ink jet system.

23. The three-dimensional image forming apparatus according to claim 21, wherein
said second forming means is an ink jet head that forms said lamination image of said three-dimensional image having said undulation corresponding to said three-dimensional object by laminating said ink solid through ejection of ink containing a thermoplastic solid or ultraviolet cure ink, and
said first forming means is an ink jet head that forms a two-dimensional image by ejecting water-based ink, oil-based ink or ultraviolet cure ink for image recording.

24. The three-dimensional image forming apparatus according to claim 21, wherein said securing means and said fixing means perform different fixation processing.

25. The three-dimensional image forming apparatus according to claim 21, wherein said first information acquiring means includes:
second information acquiring means for acquiring second height information concerning a height of said three-dimensional object from inputted three-dimensional object information; and
first information converting means for converting said second height information acquired by said second information acquiring means into desired height information with which said undulation corresponding to said three-dimensional object are reproducible on said support.

26. The three-dimensional image forming apparatus according to claim 21, wherein
said two-dimensional image information is inputted information, and
said first information acquiring means includes first information calculating means for desired height information, with which said undulation corresponding to said three-dimensional object and corresponding to at least one part of positions on said first layer image are reproducible on said support, from said inputted two-dimensional image information.

27. The three-dimensional image forming apparatus according to claim 21, wherein
said two-dimensional image information is inputted information, and
said first information acquiring means includes:
second information calculating means for calculating third height information corresponding to at least one part of positions on said first layer image from said inputted two-dimensional image information, and
second information converting means for converting said third height information calculated by said second information calculating means into desired height information with which said undulation corresponding to said three-dimensional object are reproducible on said support.

28. The three-dimensional image forming apparatus according to claim 21, wherein said first information acquiring means includes:
said second information acquiring means for acquiring second height information concerning a height of said three-dimensional object from inputted three-dimensional object information; and
third information converting means for converting said second height information acquired by said second information acquiring means into desired height information with which said undulation corresponding to said three-dimensional object are reproducible on said support based on human's visual characteristics.

29. The three-dimensional image forming apparatus according to claim 21, wherein
said two-dimensional image information is inputted information, and
said first information acquiring means includes third information calculating means for calculating height information, with which said undulation corresponding to said three-dimensional object and corresponding to at least one part of positions on said first layer image are reproducible on said support, from the inputted two-dimensional image information based on human's visual characteristics.

30. The three-dimensional image forming apparatus according to claim 21, wherein
said two-dimensional image information is inputted information, and
said first information acquiring means includes:
said second information calculating means for calculating third height information corresponding to at least one part of positions on said first layer image from said inputted two-dimensional image information; and
fourth information converting means for converting said third height information calculated by said second information calculating means into desired height information with which said undulation corresponding to said three-dimensional object are reproducible on said support based on human's visual characteristics.
